(19) United States
(12) Patent Application Publication
(10) Pub. No.: US 2026/0078298 A1
(43) Pub. Date: Mar. 19, 2026

(54) COMPOSITIONS FOR IN SITU FLUID GELATION FOR FAR-FIELD FRACTURE CONTROL

(71) Applicant: CHEVRON U.S.A. INC., San Ramon, CA (US)

(72) Inventors: Xinghui LIU, Houston, TX (US); Darren Raphael MCDUFF, Houston, TX (US); Michael James FULLER, Cypress, TX (US)

(21) Appl. No.: 19/334,506

(22) Filed: Sep. 19, 2025

Related U.S. Application Data
(60) Provisional application No. 63/696,852, filed on Sep. 19, 2024.

(51) Int. Cl. C09K 8/92; C09K 8/80

(52) U.S. Cl. CPC C09K 8/92; C09K 8/80

(57) ABSTRACT

Described herein are aqueous compositions including a gelling agent and a crosslinker.

### CROSS-REFERENCE TO RELATED APPLICATION

This application claims priority to, and the benefit of U.S. Provisional Application 63/696,852, filed on Sep. 19, 2024, the contents of which is hereby incorporated in its entirety.

### BACKGROUND

The treatment of subterranean formations penetrated by a wellbore with fracturing fluids to stimulate the production of hydrocarbons is well-established. In general, such treatments are conducted by injecting a liquid, gas, or two-phase fluid down the wellbore at sufficient pressure and flow rate to fracture the subterranean formation. A proppant material, such as sand, fine gravel, sintered bauxite, glass beads, or the like, may also be introduced into the fractures to keep the fractures open after the fracturing pressure is released. Propped fractures provide larger flow channels through which an increased quantity of a hydrocarbon may flow, thereby increasing the productivity rate of the well. Fracturing operations may be combined with gravel packing operations in a technique known as frac-packing, which combined operations are designed provide both a barrier to formation sand production as well as proppant flowback.

Compositions and methods that can provide added control of fracture formation and propagation during fracturing operations offer the ability to further improved hydrocarbon recovery from subterranean formations including unconventional formations.

### SUMMARY

Described herein are aqueous composition including: a gelling agent and an encapsulated crosslinker. In some embodiments, the crosslinking of the gelling agent within the aqueous composition occurs upon release of the crosslinker from the encapsulant.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is an illustration of a far-field fracture control with crosslinked gel and proppant on one side of an idealized bi-wing fracture (wellbore size not proportional).

FIG. 2 is an illustration of the particles in the crosslinked gel with proppant.

FIG. 3 is a graph showing a composition including 1700 ppm polymer+50 ppm titanium crosslinker at neutral pH in 2% KCl at 150° F.

FIG. 4 is a graph showing a composition including 2000 ppm polymer+100 ppm titanium crosslinker at pH 8 in saline water at 150° F.

FIG. 5 is a graph showing a composition including 2250 ppm polymer+50 ppm chromium crosslinker at unmodified pH in saline water at 150° F.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein can have the same meaning as commonly understood by one of ordinary skill in the art to which this disclosure belongs. Unless otherwise specified, all percentages are in weight percent and the pressure is in atmospheres. All citations referred to herein are expressly incorporated by reference.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The use of the term “about” applies to all numeric values, whether or not explicitly indicated. This term can refer to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” can refer to geologic formations of interest, that the term “formation,” as used herein, may, in some instances, include any geologic points or volumes of interest (such as a survey area).

“Unconventional formation” or “unconventional subterranean formation” is a subterranean hydrocarbon-bearing formation that can require intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir may need to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). In the case of an unconventional formation, the permeabilities above can refer to average permeability value for the formation. Shale formations typically have permeabilities on the order of microdarcy (μD) to nanodarcy (nD).

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (e.i., oil or petroleum), gas hydrocarbons, any combination of liquid hydrocarbons and gas hydrocarbons (e.g., including gas condensate), etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term “reservoir” or “subsurface reservoir” or “subsurface region of interest” or “subsurface formation” or “subsurface volume of interest”. For example, in some embodiments, the reservoir may be, but is not limited to, a shale reservoir, a carbonate reservoir, a tight sandstone reservoir, a tight siltstone reservoir, a gas hydrate reservoir, a coalbed methane reservoir, etc. Indeed, the terms “formation,” “reservoir,” “hydrocarbon,” and the like are not limited to any description or configuration described herein.

“Wellbore” refers to a continuous hole for use in hydrocarbon recovery, including any openhole or uncased portion of the wellbore. For example, a wellbore may be a cylindrical hole drilled into the formation such that the wellbore is surrounded by the formation, including rocks, sands, sediments, etc. A wellbore may be used for injection. A wellbore may be used for production. A wellbore may be used for hydraulic fracturing of the formation. A wellbore even may be used for multiple purposes, such as injection and production. The wellbore may have vertical, inclined, horizontal, or any combination of trajectories. For example, the wellbore may be a vertical wellbore, a horizontal wellbore, a multilateral wellbore, or slanted wellbore. The wellbore may include a “build section.” “Build section” refers to practically any section of a wellbore where the deviation is changing. As an example, the deviation is changing when the wellbore is curving. The wellbore may include a plurality of components, such as, but not limited to, a casing, a liner, a tubing string, a heating element, a sensor, a packer, a screen, a gravel pack, etc. The wellbore may also include equipment to control fluid flow into the wellbore, control fluid flow out of the wellbore, or any combination thereof. For example, each wellbore may include a wellhead, a BOP, chokes, valves, or other control devices. These control devices may be located on the surface, under the surface (e.g., downhole in the wellbore), or any combination thereof. The wellbore may also include at least one artificial lift device, such as, but not limited to, an electrical submersible pump (ESP) or gas lift. The term wellbore is not limited to any description or configuration described herein. The term wellbore may be used synonymously with the terms borehole or well.

“Slickwater,” as used herein, refers to water-based aqueous composition comprising a friction reducer which can be pumped at high rates to fracture a reservoir. Optionally when employing slickwater, smaller sized proppant particles (e.g., 40/70 or 50/140 mesh or smaller microproppant mesh sizes) are used due to the fluid having a relatively low viscosity (and therefore a diminished ability to transport sizable proppants relative to more viscous fluids). In some embodiments, proppants are added to some stages of completion/stimulation during production of an unconventional reservoir. In some embodiments, slickwater is injected with a small quantity of proppant.

“Fracturing” is one way that hydrocarbons may be recovered (sometimes referred to as produced) from the formation. For example, hydraulic fracturing may entail preparing a fracturing fluid and injecting that fracturing fluid into the wellbore at a sufficient rate and pressure to open existing fractures and/or create fractures in the formation. The fractures permit hydrocarbons to flow more freely into the wellbore. In the hydraulic fracturing process, the fracturing fluid may be prepared on-site to include at least proppants. The proppants, such as sand or other particles, are meant to hold the fractures open so that hydrocarbons can more easily flow to the wellbore. The fracturing fluid and the proppants may be blended together using at least one blender. The fracturing fluid may also include other components in addition to the proppants.

The wellbore and the formation proximate to the wellbore are in fluid communication (e.g., via perforations), and the fracturing fluid with the proppants is injected into the wellbore through a wellhead of the wellbore using at least one pump (oftentimes called a fracturing pump). The fracturing fluid with the proppants is injected at a sufficient rate and pressure to open existing fractures and/or create fractures in the subsurface volume of interest. As fractures become sufficiently wide to allow proppants to flow into those fractures, proppants in the fracturing fluid are deposited in those fractures during injection of the fracturing fluid. After the hydraulic fracturing process is completed, the fracturing fluid is removed by flowing or pumping it back out of the wellbore so that the fracturing fluid does not block the flow of hydrocarbons to the wellbore. The hydrocarbons can enter the same wellbore from the formation and go up to the surface for further processing.

The equipment to be used in preparing and injecting the fracturing fluid may be dependent on the components of the fracturing fluid, the proppants, the wellbore, the formation, etc. However, for simplicity, the term “fracturing apparatus” is meant to represent any tank(s), mixer(s), blender(s), pump(s), manifold(s), line(s), valve(s), fluid(s), fracturing fluid component(s), proppants, and other equipment and non-equipment items related to preparing the fracturing fluid and injecting the fracturing fluid.

Other hydrocarbon recovery processes may also be utilized to recover the hydrocarbons. Furthermore, those of ordinary skill in the art will appreciate that one hydrocarbon recovery process may also be used in combination with at least one other recovery process or subsequent to at least one other recovery process. Moreover, hydrocarbon recovery processes may also include stimulation or other treatments.

“Friction reducer,” as used herein, refers to a chemical additive that alters fluid rheological properties to reduce friction created within the fluid as it flows through small-diameter tubulars or similar restrictions (e.g., valves, pumps). Polymers, or similar friction reducing agents, can add viscosity to the fluid, which reduces the turbulence induced as the fluid flows. Reductions in fluid friction of greater than 50% are possible depending on the friction reducer utilized, which allows the aqueous composition to be injected into a wellbore at a much higher injection rate (e.g., between 5 to 150 barrels per minute) and also lower pumping pressure during proppant injection.

The term “interfacial tension” or “IFT” as used herein refers to the surface tension between test oil and water of different salinities containing a surfactant formulation at different concentrations. Interfacial tensions can be measured using a spinning drop tensiometer or calculated from phase behavior experiments.

The term “proximate” is defined as “near.” If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The term “contacting” as used herein, refers to materials or compounds being sufficiently close in proximity to react or interact. For example, in methods of contacting an unrefined petroleum material, a hydrocarbon-bearing formation, and/or a wellbore, the term “contacting” can include placing a compound (e.g., a surfactant) or an aqueous composition (e.g., chemical, surfactant, or polymer) within a hydrocarbon-bearing formation using any suitable manner known in the art (e.g., pumping, injecting, pouring, releasing, displacing, spotting, or circulating the chemical into a well, wellbore, or hydrocarbon-bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit,” “deposit,” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes may yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH, NaHCO₃, or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. The less viscous a fluid is, the greater its ease of fluidity.

The term “gel,” and related terms such as “crosslinked gel,” as used herein, refers to a semi-solid, jelly-like state assumed by some colloidal dispersions. Crosslinked gels, in particular, are gels formed by mixing a gelling agent with a crosslinking agent.

Unless defined otherwise, all technical and scientific terms used herein have the same meanings as commonly understood by one of skill in the art to which the disclosed invention belongs. Unless otherwise specified, all percentages are in weight percent and the pressure is in atmospheres. All citations referred to herein are expressly incorporated by reference.

Reference will now be made in detail to specific aspects of the disclosed materials, compounds, compositions, articles, and methods, examples of which are illustrated in the accompanying Examples and Figures.

### Methods

Hydraulic fracturing operations use high rates, high pressures, and carefully designed aqueous fluids to deploy solid propping agent throughout the inner volume of induced hydraulic fractures. The ultimate 3-dimensional geometry of the induced fractures (and resulting propped fractures) is impacted by many factors, including the pump rate and proppant concentration (commonly known as pump schedule); formation stresses; geomechanical properties (such as Young's modulus); the presence of barriers (to frac height growth); induced stresses (such as stress shadow); and other factors. While some of these variables can be altered by varied pumping parameters, a number of these factors are highly influenced by natural parameters of the formation itself which are more difficult to mitigate.

One factor that is often modified to change the hydraulic and propped fracture geometry is the fluid viscosity. Hydraulic fracturing designs deployed viscous fluids to carry a schedule with a sequence of increasing proppant concentrations. With viscous fluids (viscosities >20 cP, and up to 1,000 cP for some challenging frac and frac-pack operations) pumped at lower-medium rates, the resulting fracture geometry is generally understood to form traditional “biwing” propped fractures. These viscous fluids are capable of carrying much higher concentrations of proppant than thin fluids and have also been shown to reduce height growth (sometimes through the resultant lower pump rate used in their execution). However, viscous fluids may include formation damage from higher gel loadings and the resultant higher friction pressure in their deployment, leading to the need to deploy those fracs at lower rates to compensate for friction pressure, in order to stay below max pumping pressures.

Aqueous fluids in the fracturing of shale and tight reservoirs can include slickwater to lower cost, increase fracture surface area and reduce formation damage. Most shale and tight wells are completed with multiple stages along the horizontal laterals in the target formation. Each stage includes multiple perforation clusters in a section of the horizontal wellbore and is stimulated under fracturing conditions in a treatment. Such completion practices may lead to interactions of multiple fractures within the same stage and from previous stage(s). Reservoir heterogeneity, lateral landing depth variation, uneven perforation and perforation erosion by proppant can also be an issue.

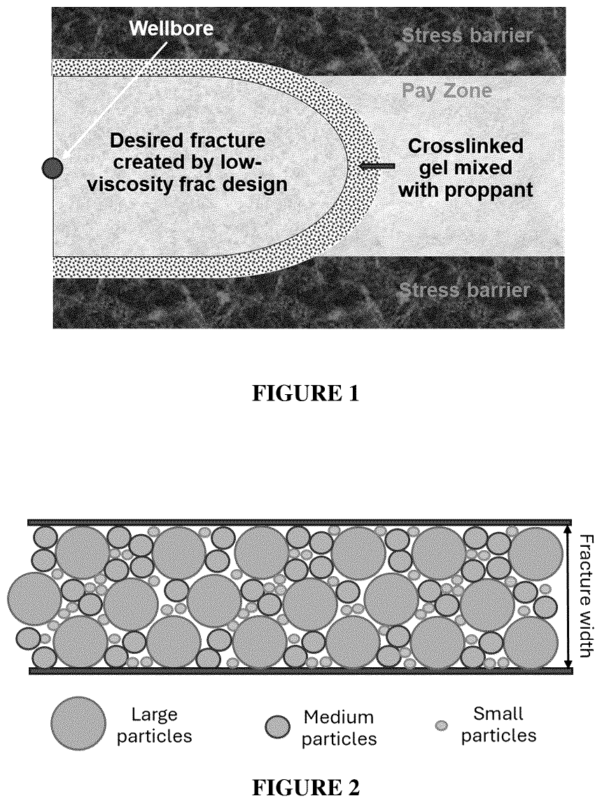

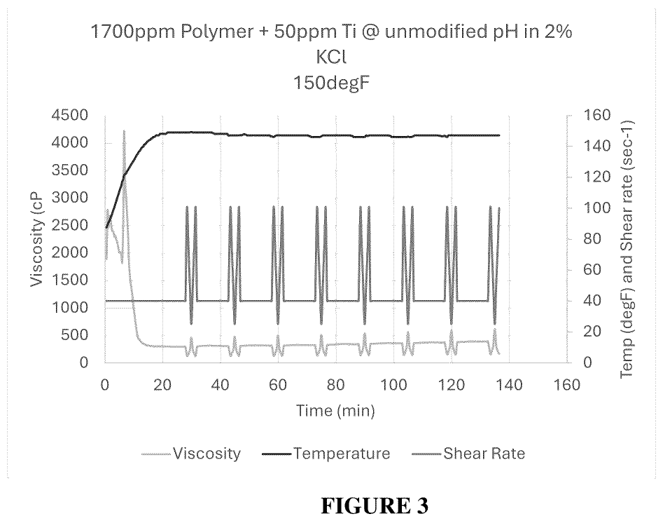

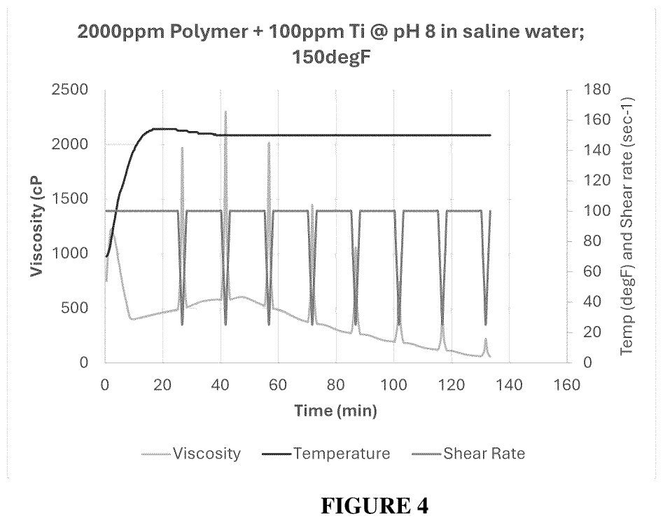

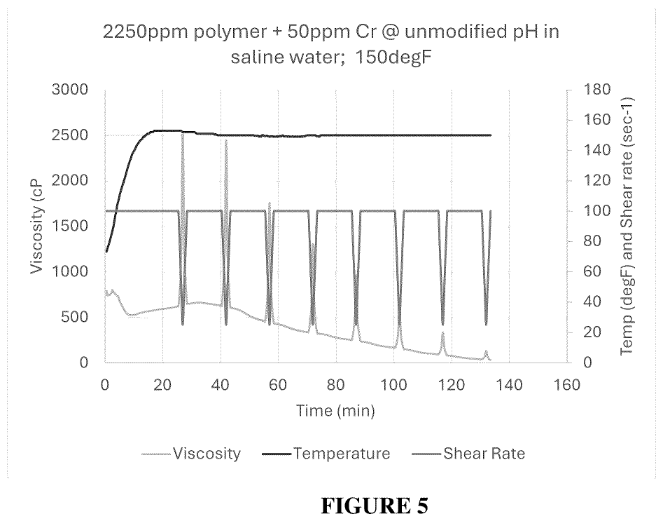

Described are methods for fracture control in both horizontal and vertical directions in low-viscosity fracture designs. The methods described herein delay generation of an aqueous composition with high viscosity carrying proppants with optimal particle size distribution to the far-field, to control a fracture with desired geometry. In some embodiments, the methods can limit height and length growth of at least one fracture (e.g., hydraulic fracture, and/or naturally occurring fracture). This process is conceptually illustrated in FIG. 1, which is achieved by pumping an aqueous composition with delayed generation of high viscosity in a typical low viscosity frac design. The methods can involve delayed generation of high viscosity until a time that a gelling agent and a crosslinker are within at least one fracture.

The methods for far-field fracture control involve means to control activation of the crosslinking of various portions of the aqueous composition. To achieve this control, the aqueous composition can include gelling agents through the portions or all the frac design where far-field frac geometry control is desired. This crosslinkable portion can be part of the base fluid for the entire frac treatment, such as the friction reducer polymer itself in a slickwater fluid. In some embodiments, the concentration of friction reducer might be increased to a higher-viscosity friction reducer concentration more capable of crosslinking. Alternatively, a gelling agent capable of crosslinking can be added to portions of the frac treatment in addition to the friction reducer.

In some embodiments, the gelling agent can be included in a concentration suitable for controlled crosslinking only in early phases of the frac stage where fracture control is needed, such as the pad stage (initial frac fluid pumped without proppant to create a fracture with sufficient dimensions). In some embodiments, the gelling agent can be added in both the pad and some portion of the proppant-laden slurry stage.

The other portion achieving delayed viscosity-increase for far-field fracture control can be through the use of encapsulated crosslinkers, whose chemistry is chosen specific to the gelling agent. The coating of the crosslinker can protect the crosslinker and delay its chemical interaction with the gelling agent which can allow for far-field fracture control. Upon release from the encapsulated state, the crosslinker can encounter the gelling agent and under appropriate temperature and pH conditions lead to crosslinking and rapid local generation of high viscosity. In some embodiments a macroscopic crosslinking of a large continuous volume of gelling agent can be present, leading to “plugging” and controlling far-field fracture geometry. In some embodiments, the crosslinking can be “localized” leading to smaller volumes of highly viscous aqueous composition carrying a proppant such as proppant with wider particle size distribution (e.g., from 140 mesh to 625 mesh) that creates similar plugging that leads to control of fracture growth.

The release mechanisms can include coatings that, during transport into the fracture, slowly dissolve; abrasively lose integrity; slowly melt (on exposure to elevated temperature); and degrade through other mechanisms. In each of these mechanisms, the majority of crosslinker will be released from the coating once inside the fracture, in some distance away from the wellbore, for example, at some extended length of the fracture in the far-field. In some embodiments, the crosslinker may first undergo some partial release of trace concentrations of crosslinker either during transit down the casing or near to the perforations. In some embodiments, the largest portion of crosslinker can be released from the encapsulant around the outer perimeter of the desired fracture geometry.

In some embodiments, the encapsulated crosslinker can be added throughout the pad and early portions of proppant slurry (consistent with those portions of the frac design that contain gelling agent), to form a gel deeper into the fracture to control the fracture geometry in the far-field. In some embodiments, the methods can include the encapsulated crosslinker in an early aqueous composition (with low proppant loading), or only in the pad stage (no proppant). The optimal timing to introduce the encapsulated crosslinker, gelling agent and proppants (e.g., proppants with wider particle size distribution) depends on fracture growth rate and desired final fracture geometry. In some embodiments, the specific gravity of the encapsulated crosslinker can impact portions of the job. If encapsulated crosslinkers have a higher specific gravity, such as greater than 1.5 the encapsulated crosslinker particles may settle into the proppant dune rather than transport to the deeper portions of the frac for far-field control. Reducing the size of the crosslinker and/or increasing the viscosity of the gelling agent can mitigate the specific gravity impact. In some embodiments, the encapsulated crosslinker can be transported deep into the fracture for highest effectiveness.

In some embodiments, a pressure response may be observed that indicates fracture growth has occurred when practicing the methods described herein. The pressure response can indicate a change in fracture geometry, a growth in fractures from one direction to another, or a combination thereof. In some embodiments, the methods described herein can control fracture growth, control fracture geometry, or a combination thereof.

Described herein are methods including: injecting an aqueous composition including a gelling agent and an encapsulated crosslinker into at least one fracture present in a subterranean formation via a wellbore in fluid communication with the subterranean formation; displacing the gelling agent and encapsulated crosslinker to a desired location within the subterranean formation such that the aqueous composition flows into at least one fracture of the subterranean formation; allowing for release of the crosslinker from its encapsulant, thereby crosslinking the gelling agent within the fracture. In some embodiments, upon crosslinking of the gelling agent, the aqueous composition forms a gel within the at least one fracture in the subterranean formation. In some embodiments, the gel is effective to at least partially control far-field fracture geometry during a fracturing operation performed via the wellbore. In some embodiments, the subterranean formation is an unconventional subterranean formation. In some embodiments, the gel is a flowing gel.

Described herein are also methods including injecting an aqueous composition comprising a gelling agent and a crosslinker into at least one fracture present in a subterranean formation via a wellbore in fluid communication with the subterranean formation; displacing the gelling agent and the crosslinker to a desired location within the at least one fracture present in the subterranean formation; and optionally exposing the aqueous composition to an external trigger, thereby crosslinking the gelling agent within the at least one fracture. In some embodiments, crosslinking of the gelling agent within the aqueous composition can be a delayed crosslinking. In some embodiments, crosslinking can be delayed by a chemical delay agent. In some embodiments, chemical delay agents can interact with the crosslinker to delay crosslinking with the gelling agent. In some embodiments, the aqueous composition can further include a chemical delay agent such as organic complexing agents/metal chelating agents (e.g., citrate, EDTA, lactate, acetate, citrate, NTA, HEDTA, or DTPA). In some embodiments, the crosslinker can be encapsulated. In some embodiments, the crosslinker can be unencapsulated. In some embodiments, exposure of the crosslinker to an external trigger could be delayed by chemical delay agents interacting with the crosslinker to delay crosslinking with the gelling agent. In some embodiments, delayed crosslinking can be accelerated upon exposure of the aqueous composition or crosslinker to an external trigger, thereby crosslinking the gelling agent. In some embodiments, delayed activation of crosslinking could apply to crosslinkers such as borates and metal crosslinkers. In some embodiments, crosslinking of the gelling agent within the aqueous composition can occur upon optional exposure of the aqueous composition to an external trigger such as a change in pH, pressure, temperature, or salinity. In some embodiments, the external trigger can be a change in temperature (e.g., exposure to elevated temperature (e.g., from 75° F. to 350° F.) for an extended exposure time).

Controlled activation of crosslink can bring multiple benefits to the overall fracture procedure. Delay of the crosslink reaction to some point below the surface during frac procedure will first reduce the friction experienced during transit to the target zone, reducing overall friction losses. Delay of the crosslink reaction may limit possible shear degradation of a crosslinked gel that may be experienced before the portions of the fracture where the fracture containment action of the gelled fluid is required.

In some embodiments, upon crosslinking of the gelling agent, the aqueous composition increases in viscosity by at least one order of magnitude, such as at least two orders of magnitude, or at least three orders of magnitude.

In some embodiments, after crosslinking of the gelling agent within the fracture, the method can further include injecting an aqueous composition through the wellbore at a pressure and flow rate effective to form, continue to form, or extend a fracture in the subterranean formation.

In some embodiments, crosslinking of the gelling agent within the fracture can inhibit growth of fractures in the first region. In some embodiments, crosslinking of the gelling agent within the fracture can preferentially direct the growth of fractures toward a different direction or a second region of the subterranean formation. In some embodiments, crosslinking of the gelling agent within the fracture can inhibit initiation of fractures in the first region. In some embodiments, crosslinking of the gelling agent within the fracture can preferentially direct the initiation of fractures toward a different direction or a second region of the subterranean formation. In some embodiments, crosslinking of the gelling agent within the fracture can increase fracture formation in a second region of the subterranean formation.

In some embodiments, the method can further include producing fluids from the wellbore. In some embodiments, the fluids can include hydrocarbons.

In some embodiments, displacing the gelling agent and encapsulated crosslinker to a desired location within the subterranean formation can include injecting a displacement fluid through the wellbore after injection of the aqueous composition so as to drive the aqueous composition further into the at least one fracture. In some embodiments, the displacement fluid can include an aqueous injection fluid such as slickwater.

In some embodiments, the aqueous composition can further include a breaking agent, an encapsulated breaking agent, or any combination thereof. In some embodiments, the aqueous composition can further include a breaking agent. In some embodiments, the aqueous composition can further include an encapsulated breaking agent. In some embodiments, the breaking agent can be released from its encapsulant, thereby at least partially removing the crosslinked gelling agent from the fracture. In some embodiments, the breaking agent can be released after crosslinking of the gelling agent within the fracture. In some embodiments, after crosslinking of the gelling agent within the fracture, the method can further include injecting a breaking composition into the wellbore.

In some embodiments, the subterranean formation can be a subsea reservoir and/or subsurface reservoir.

In some embodiments, the subterranean formation can have a temperature of at least 75° F. (e.g., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 185° F., at least 190° F., at least 195° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The subterranean formation can have a temperature ranging from any of the minimum values described above to any of the maximum values described above. For example, in some embodiments, the subterranean formation can have a temperature of from 75° F. to 350° F. (approximately 24° C. to 176° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of unconventional subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of subterranean formation can range from any of the minimum values described above to any of the maximum values described above. For example, in some embodiments, the salinity of subterranean formation can be from 5,000 ppm TDS to 300,000 ppm TDS (e.g., from 100,000 ppm to 300,000 ppm TDS, from 200,000 ppm to 300,000 ppm TDS, from 100,000 ppm to 200,000 ppm TDS, from 10,000 ppm to 100,000 ppm TDS, from 10,000 ppm to 200,000 ppm TDS, from 10,000 ppm to 300,000 ppm TDS, from 5,000 ppm to 100,000 ppm TDS, from 5,000 ppm to 200,000 ppm TDS, from 5,000 ppm to 10,000 ppm TDS, or from 5,000 ppm to 50,000 ppm TDS).

### Compositions

Aqueous composition as described herein can be optimized for each formation and/or for the desired oil and gas operation. For example, an aqueous composition can be tested at a specific reservoir temperature and salinity, and with specific additional components. Actual native reservoir fluids may also be used to test the compositions.

Described herein are aqueous composition including a gelling agent and an encapsulated crosslinker. In some embodiments, crosslinking of the gelling agent within the aqueous composition occurs upon release of the crosslinker from the encapsulant.

In some embodiments, prior to injection into the subterranean formation, the aqueous composition can have a viscosity of 20 cP or less at 25° C. measured at a shear rate of 170 sec-1 and, such as 10 cP or less, or 5 cP or less. In some embodiments, upon crosslinking of the gelling agent, the aqueous composition can have a viscosity of at least 50 cP at 25° C. measured at a shear rate of 170 sec-1, such as at least 100 cP, at least 250 cP, at least 500 cP, at least 1000 cP, at least 1500 cP, or at least 2000 cP.

For example, the aqueous composition including a gelling agent and encapsulated crosslinker can have a viscosity of less than or equal to 20 cP. Upon release of the crosslinker and crosslinking of the gelling agent in the far-field fracture, the viscosity of the crosslinked portions of the fluid may increase by several orders, such as greater than 200 cP during frac execution. These areas of heightened viscosity may be a large portion of the aqueous composition and optionally aqueous composition/proppant slurry.

In some embodiments, the aqueous composition can further include a breaking agent, an encapsulated breaking agent, or any combination thereof. In some embodiments, the aqueous composition can further include a breaking agent. In some embodiments, the aqueous composition can further include an encapsulated breaking agent. In some embodiments, the breaking agent can be released from its encapsulant, thereby at least partially removing the crosslinked gelling agent from the fracture. In some embodiments, the breaking agent can be released after crosslinking of the gelling agent within the fracture. In some embodiments, after crosslinking of the gelling agent within the fracture, the method can further include injecting a breaking composition into the wellbore.

Suitable breaking agents can include, but are not limited to a peroxide, a persulfate, a perphosphate, a perborate, a percarbonate, a persilicate, an oxyacid of a halogen, an oxyanion of halogen, a peracid, a derivative thereof, or any combination thereof.

In some embodiments, after fracture control (and the end of frac execution operations), the aqueous composition viscosity can decrease to less than 20 cP, such as less than 10 cP, or less than 5 cP by using a breaking agent (e.g., oxidative breaker chemicals). The breaking agent could be added in either “live” (soluble) or in an encapsulated form of the breaking agent pumped at the same time with the encapsulated crosslinker, conditions are selected to ensure that the breaking agent does activate prematurely.

In some embodiments, the crosslinker can be chosen from organic crosslinkers, aluminates, borates, zirconates, chromates, titanates, and combinations thereof.

In some embodiments, the encapsulated crosslinker can include a crosslinker at least partially encapsulated within a dissolvable coating, frangible coating, meltable coating, soft-gel coating, degradable coating, or any combination thereof.

In some embodiments, the encapsulated crosslinker can include a crosslinker at least partially encapsulated within a dissolvable coating. In some embodiments, the dissolvable coating can include dissolvable salts, soluble polymer, or any combination thereof. For example, the coating can be applied as a solid and will only dissolve after extended exposure to aqueous composition, such as the transit time from the blender through the casing and into the fracture. This coating can include one of numerous polymers, inorganic salts, and other materials with delayed solubility in aqueous composition. Optionally, the coatings solubility can increase with elevated temperatures. For example, a coating could be insoluble or sparingly soluble at ambient temperatures; then the coating can increase in solubility as the fluid increases in temperature (specifically reaching elevated or reservoir temperatures in the far-field of the desired fracture geometry).

In some embodiments, the encapsulated crosslinker can include a crosslinker at least partially encapsulated within a frangible coating. In some embodiments, the frangible coating can include a polymeric coating. In some embodiments, the polymeric coating comprises polyvinylidene chloride (PVDC), crosslinked acrylic, and resins (e.g., phenolic, and urea formaldehyde resin). For example, thin coatings that first harden around the crosslinker. These can include, for example, crosslinked polymers, thin inorganic coatings such as silicates; and others. During transit downhole, the coatings can undergo abrasion specifically during transit in the fracture, leading to a release of the crosslinker.

In some embodiments, the encapsulated crosslinker can include a crosslinker at least partially encapsulated within a meltable coating. For example, the coating can degrade from the crosslinker through melting at elevated temperatures, specifically the temperatures predicted inside the fracture during frac execution. In some embodiment, the coatings can include commercial wax materials designed to melt above certain minimum threshold temperatures.

In some embodiments, the encapsulated crosslinker can include a crosslinker at least partially encapsulated within a soft-gel coating. For example, the crosslinker core can be in a nonaqueous liquid form, in some embodiments, in higher viscosity; and the nonaqueous core can be protected with a coating of amphiphilic organic chemicals such as a surfactants. The resulting material forms “soft-gel” materials which can maintain their protected spherical form during execution; but during transit, the coating can deteriorate and release the crosslinker to react with the crosslinkable gelling agent in the aqueous composition.

In some embodiments, the encapsulated crosslinker includes a crosslinker at least partially encapsulated within a degradable coating. In some embodiments, the degradable coating can degrade in response to an external trigger: For example, the coating can have a low solubility initially during transport into the fracture; but on response to a change in the surrounding aqueous composition environment, the solubility of the coating can increase. In some embodiments, the degradable coating can degrade in response to an external trigger. In some embodiments, the external trigger can include but is not limited to a change in pH, pressure, temperature, salinity, or any combination thereof. For example, in some embodiments, the degradable coating can be acid soluble (e.g., calcium carbonate). In some embodiments, the degradable coating can be an ultrathin coating shattered by ultrasonic stimulus. In some embodiments, the degradable coating can include swellable polymers that shrink in response to change in salinity and release the crosslinker. In some embodiments, the degradable coating can include a pH reactive material. In some embodiments, the coating can be an inert coatings with degradable defects. For example, the coating can include a mixture of materials; this mixture can include a majority of insoluble material (such as polymers, optionally crosslinked) that are blended with degradable materials that incorporate into the coating like defects. These defect materials can include one of materials that degrade through slow solubility (that optionally may increase with elevated temperature), melting at elevated temperature, or dissolve with an external trigger. Upon degradation of those coating defects, the crosslinker can be accessible to the aqueous composition and release from the protective core to initiate crosslinking.

In some embodiments, the crosslinker can include a solid crosslinker or a liquid crosslinker. In some embodiments, the crosslinker can include a solid crosslinker. In some embodiments, the crosslinker can include a solid crosslinker can have rapid solubility in an aqueous composition upon release from the encapsulant. In some embodiments, the crosslinker can include a solid crosslinker can have slow solubility in an aqueous composition upon release from the encapsulant.

In some embodiments, the crosslinker includes a liquid crosslinker. In some embodiments, the liquid crosslinker is adsorbed to a solid carrier. In some embodiments, the liquid crosslinker is adsorbed to an inert solid carrier. Suitable inert solid carriers can include, but are not limited to talc, zeolites, or diatomaceous earth.

The particle size of encapsulated crosslinker material can be varied depending on the end application or action in the fracture (such as a small size of encapsulated crosslinker for transport into the far-field fracture). The encapsulated crosslinker can also vary based on constraints during manufacture (such as limitations on the original size of crosslinker to be coated). These are nonlimiting examples of factors that can impact the particle size of the encapsulated crosslinkers, though many other variables in design can apply.

The slow release of a crosslinker from the encapsulant can delay the crosslinking of the gelling agents. This delay can be imparted through various forms and materials of encapsulant coating. Suitable coatings and release mechanisms can include, but is not limited to dissolvable coating (e.g., slowly soluble coating), frangible (abrasion-degraded) coatings, meltable coatings, “soft-gel” coating, degradable coatings, and inert coatings.

In some embodiments, the gelling agent can include a polymer. Suitable polymers can include, but are not limited biopolymers such as polysaccharides. For example, polysaccharides can be xanthan gum, scleroglucan, guar gum, hydroxypropyl guar (HPG), carboxymethyl hydroxypropyl guar (CMHPG), a mixture thereof (e.g., any modifications thereof such as a modified chain), etc. Indeed, the terminology “mixtures thereof” or “combinations thereof” can include “modifications thereof” herein.

In some embodiments, the polymer can include one or more synthetic (co) polymers, such as one or more acrylamide containing (co) polymers. As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. A polymer may be a “homopolymer” comprising substantially identical recurring units formed by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units. The term “polymer” as used herein is intended to include both the acid form of the polymer as well as its various salts.

In some embodiments, the one or more synthetic (co) polymers can be a polymer useful for enhanced oil recovery applications. The term “enhanced oil recovery” or “EOR” (also known as tertiary oil recovery), refers to a process for hydrocarbon production in which an aqueous composition comprising at least a water soluble polymer is injected into a hydrocarbon bearing formation.

In some embodiments, the one or more synthetic (co) polymers can include water-soluble synthetic (co) polymers. Examples of suitable synthetic (co) polymers can include acrylic polymers, such as polyacrylic acids, polyacrylic acid esters, partly hydrolyzed acrylic esters, substituted polyacrylic acids such as polymethacrylic acid and polymethacrylic acid esters, polyacrylamides, partly hydrolyzed polyacrylamides (HPAMs or PHPAs), and polyacrylamide derivatives such as acrylamide tertiary butyl sulfonic acid (ATBS); copolymers of unsaturated carboxylic acids, such as acrylic acid or methacrylic acid, with olefins such as ethylene, propylene and butylene and their oxides; polymers of unsaturated dibasic acids and anhydrides such as maleic anhydride; vinyl polymers, such as polyvinyl alcohol (PVA), N-vinylpyrrolidone, and polystyrene sulfonate; and copolymers thereof, such as copolymers of these polymers with monomers such as ethylene, propylene, styrene, methylstyrene, and alkylene oxides. In some embodiments, the one or more synthetic (co) polymer can comprise polyacrylic acid (PAA), polyacrylamide (PAM), acrylamide tertiary butyl sulfonic acid (ATBS) (or AMPS, 2-acrylamido-2-methylpropane sulfonic acid), N-vinylpyrrolidone (NVP), polyvinyl alcohol (PVA), or a blend or copolymer of any of these polymers. Copolymers may be made of any combination above, for example, a combination of NVP and ATBS. In certain examples, the one or more synthetic (co) polymers can comprise acrylamide tertiary butyl sulfonic acid (ATBS) (or AMPS, 2-acrylamido-2-methylpropane sulfonic acid) or a copolymer thereof.

In some embodiments, the one or more synthetic (co) polymers can include acrylamide (co) polymers. In some embodiments, the one or more acrylamide (co) polymers can include water-soluble acrylamide (co) polymers. In various embodiments, the acrylamide (co) polymers comprise at least 30% by weight, or at least 50% by weight acrylamide units with respect to the total amount of all monomeric units in the (co) polymer.

Optionally, the acrylamide-(co) polymers can include, besides acrylamide, at least one additional co-monomer. In example embodiments, the acrylamide-(co) polymer may comprise less than about 50%, or less than about 40%, or less than about 30%, or less than about 20% by weight of the at least one additional co-monomer. In some embodiments, the additional comonomer can be a water-soluble, ethylenically unsaturated, in particular monoethylenically unsaturated, comonomer. Suitable additional water-soluble comonomers include comonomers that are miscible with water in any ratio, but it is sufficient that the monomers dissolve sufficiently in an aqueous phase to copolymerize with acrylamide. In some cases, the solubility of such additional monomers in water at room temperature can be at least 50 g/L (e.g., at least 150 g/L, or at least 250 g/L).

Other suitable water-soluble comonomers can include one or more hydrophilic groups. The hydrophilic groups can be, for example, functional groups that include one or more atoms selected from the group of O-, N-, S-, and P-atoms. Examples of such functional groups include carbonyl groups >C—O, ether groups —O—, in particular polyethylene oxide groups —(CH₂—CH₂—O—)ₙ—, where n is preferably a number from 1 to 200, hydroxy groups —OH, ester groups —C(O)O—, primary, secondary or tertiary amino groups, ammonium groups, amide groups —C(O)—NH— or acid groups such as carboxyl groups —COOH, sulfonic acid groups —SO₃H, phosphonic acid groups —PO₃H₂ or phosphoric acid groups —OP(OH)₃.

Examples of monoethylenically unsaturated comonomers including acid groups include monomers comprising-COOH groups, such as acrylic acid or methacrylic acid, crotonic acid, itaconic acid, maleic acid or fumaric acid, monomers comprising sulfonic acid groups, such as vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid, or monomers comprising phosphonic acid groups, such as vinylphosphonic acid, allylphosphonic acid, N-(meth)acrylamidoalkylphosphonic acids or (meth)acryloyloxyalkyl-phosphonic acids. Of course the monomers may be used as salts.

The —COOH groups in polyacrylamide-copolymers may not only be obtained by copolymerizing acrylic amide and monomers comprising —COOH groups but also by hydrolyzing derivatives of —COOH groups after polymerization. For example, the amide groups —CO—NH₂ of acrylamide may hydrolyze thus yielding-COOH groups.

Also to be mentioned are derivatives of acrylamide thereof, such as, for example, N-methyl(meth)acrylamide, N,N′-dimethyl(meth)acrylamide, and N-methylolacrylamide, N-vinyl derivatives such as N-vinylformamide, N-vinylacetamide, N-vinylpyrrolidone or N-vinylcaprolactam, and vinyl esters, such as vinyl formate or vinyl acetate. N-vinyl derivatives can be hydrolyzed after polymerization to vinylamine units, vinyl esters to vinyl alcohol units.

Other example comonomers include monomers comprising hydroxy and/or ether groups, such as, for example, hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates.

Other example comonomers are monomers having ammonium groups, i.e monomers having cationic groups. Examples comprise salts of 3-trimethylammonium propylacrylamides or 2-trimethylammonium ethyl(meth)acrylates, for example the corresponding chlorides, such as 3-trimethylammonium propylacrylamide chloride (DIMAPAQUAT) and 2-trimethylammonium ethyl methacrylate chloride (MADAME-QUAT).

Other example monoethylenically unsaturated monomers include monomers which may cause hydrophobic association of the (co) polymers. Such monomers comprise besides the ethylenic group and a hydrophilic part also a hydrophobic part. Such monomers are disclosed for instance in WO 2012/069477, which is incorporated herein by reference in its entirety.

Other example comonomers include N-alkyl acrylamides and N-alkyl quaternary acrylamides, where the alkyl group comprises, for example, a C2-C28 alkyl group.

In certain embodiments, each of the one or more acrylamide-(co) polymers can optionally comprise crosslinking monomers, i.e. monomers comprising more than one polymerizable group. In certain embodiments, the one or more acrylamide-(co) polymers may optionally comprise crosslinking monomers in an amount of less than 0.5%, or 0.1%, by weight, based on the amount of all monomers.

In an embodiment, each of the one or more acrylamide-(co) polymers includes at least one monoethylenically unsaturated comonomer comprising acid groups, for example monomers which include at least one group selected from —COOH, —SO₃H or —PO₃H₂. Examples of such monomers include but are not limited to acrylic acid, methacrylic acid, vinylsulfonic acid, allylsulfonic acid or 2-acrylamido-2-methylpropanesulfonic acid, particularly preferably acrylic acid and/or 2-acrylamido-2-methylpropanesulfonic acid and most preferred acrylic acid or the salts thereof. The amount of such comonomers comprising acid groups can be from 0.1% to 70%, from 1% to 50%, or from 10% to 50% by weight based on the amount of all monomers.

In an embodiment, each of the one or more acrylamide-(co) polymers comprise from 50% to 90% by weight of acrylamide units and from 10% to 50% by weight of acrylic acid units and/or their respective salts, based on the total weight of all the monomers making up the copolymer. In an embodiment, each of the one or more acrylamide-(co) polymers comprise from 60% to 80% by weight of acrylamide units and from 20% to 40% by weight of acrylic acid units, based on the total weight of all the monomers making up the copolymer.

In some embodiments, the one or more synthetic (co) polymers (e.g., the one or more acrylamide (co) polymers) are in the form of particles, which are dispersed in the solution. In some embodiments, the particles of the one or more synthetic (co) polymers can have an average particle size of from 0.4 μm to 5 μm, or from 0.5 μm to 2 μm. Average particle size refers to the d₅₀ value of the particle size distribution (number average) as measured by laser diffraction analysis.

In some embodiments, the one or more synthetic (co) polymers (e.g., the one or more acrylamide (co) polymers) can have a weight average molecular weight (Mw) of from 5,000,000 g/mol to 30,000,000 g/mol; from 10,000,000 g/mol to 25,000,000 g/mol; or from 15,000,000 g/mol to 25,000,000 g/mol.

In some embodiments, suitable polymers can include synthetic polymers such as polyacrylamides. Examples of suitable polymers include synthetic polymers such as partially hydrolyzed polyacrylamides (HPAMs or PHPAs) and hydrophobically-modified associative polymers (APs). Also included are co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS. Indeed, the terminology “mixtures thereof” or “combinations thereof” can include “modifications thereof” herein.

In some embodiments, the gelling agent can include, but are not limited to partially hydrolyzed polyacrylamides (HPAMs or PHPAs), polyacrylamides, polyacrylic acid (PAA), polyvinyl alcohol (PVA), co-polymers of polyacrylamide (PAM), 2-acrylamido 2-methylpropane sulfonic acid (and/or sodium salt) commonly referred to as AMPS (e.i., acrylamido tertiobutyl sulfonic acid or ATBS), N-vinyl pyrrolidone (NVP), guar, hydroxypropyl guar (HPG), carboxymethyl hydroxypropyl guar (CMHPG), and xanthan, or any combination thereof.

In some embodiments, the gelling agent can include partially hydrolyzed polyacrylamide (HPAM), polyacrylamide, or a blend or copolymer thereof, and wherein the crosslinker is chosen from aluminates, borates, zirconates, chromates, titanates, and combinations thereof.

In some embodiments, the gelling agent includes a biopolymer, for example a polysaccharide such as guar, hydroxypropyl guar (HPG), carboxymethyl hydroxypropyl guar (CMHPG), xanthan, or a blend or copolymer thereof, and wherein the crosslinker is chosen from borates, zirconates, titanates, and combinations thereof.

The selection of a crosslinker can be based on numerous properties of the polymer, the desired viscosity, and the time to achieve crosslinking.

In some embodiments, the polymer can be present in the aqueous composition at a concentration of at least 1 lbm/Mgal (e.g., at least 5 lbm/Mgal, at least 10 lbm/Mgal, at least 15 lbm/Mgal, or at least 20 lbm/Mgal). In some embodiments, the polymer can be present in the aqueous composition at a concentration of 25 lbm/Mgal or less (e.g., 20 lbm/Mgal or less, 15 lbm/Mgal or less, 10 lbm/Mgal or less, or 5 lbm/Mgal or less).

The polymer can be present in the aqueous composition at a concentration ranging from any of the minimum values described above to any of the maximum values described above. For example, in some embodiments, the polymer can be present in the aqueous composition at a concentration from 1 lbm/Mgal to 24 lbm/Mgal (e.g., from 1 lbm/Mgal to 20 lbm/Mgal, from 1 lbm/Mgal to 15 lbm/Mgal, from 1 lbm/Mgal to 10 lbm/Mgal, from 1 lbm/Mgal to 5 lbm/Mgal, from 5 lbm/Mgal to 10 lbm/Mgal, from 5 lbm/Mgal to 15 lbm/Mgal, from 5 lbm/Mgal to 20 lbm/Mgal, from 5 lbm/Mgal to 24 lbm/Mgal, from 10 lbm/Mgal to 15 lbm/Mgal, from 10 lbm/Mgal to 20 lbm/Mgal, from 10 lbm/Mgal to 24 lbm/Mgal, from 15 lbm/Mgal to 20 lbm/Mgal, from 15 lbm/Mgal to 24 lbm/Mgal, or from 20 lbm/Mgal to 24 lbm/Mgal).

In some embodiments, the polymer can be present in the aqueous composition at a concentration of from 0.005% to 0.5% by weight of the aqueous composition (e.g., from 0.010% to 0.3% by weight, from 0.010% to 0.2% by weight, from 0.010% to 0.1% by weight, or from 0.012% to 0.28% by weight). In some embodiments, the polymer can be present in the aqueous composition at a concentration of from 0.012% to 0.28% by weight of the aqueous composition.

In some embodiments, the aqueous composition can include slickwater.

In some embodiments, the aqueous composition has a pH of at least 1 (e.g., at least 2, at least 3, at least 4, at least 5, at least 6, at least 7, or at least 8).

In some embodiments, the aqueous composition can have a pH of 9 or less (e.g., 8 or less, 7 or less, 6 or less, 5 or less, 4 or less, 3 or less, or 2 or less).

The aqueous composition can have a pH ranging from any of the minimum values described above to any of the maximum values described above. For example, in some embodiments, the aqueous composition can have a pH of from 1 to 9 (e.g., a pH of from 1 to 8, pH of from 1 to 7, pH of from 1 to 6, pH of from 1 to 5, a pH of from 1 to 4, a pH of from 1 to 3, a pH of from 1 to 2, a pH of from 2 to 9, a pH of from 2 to 8, pH of from 2 to 7, pH of from 2 to 6, pH of from 2 to 5, a pH of from 2 to 4, a pH of from 2 to 3, a pH of from 3 to 9, a pH of from 3 to 8, pH of from 3 to 7, pH of from 3 to 6, pH of from 3 to 5, pH of from 3 to 4, a pH of from 4 to 9, a pH of from 4 to 8, pH of from 4 to 7, pH of from 4 to 6, pH of from 4 to 5, pH of from 5 to 6, pH of from 5 to 7, pH of from 5 to 8, pH of from 5 to 9, pH of from 6 to 9, pH of from 6 to 8, pH of from 6 to 7, pH of from 7 to 8, pH of from 7 to 9, or pH of from 8 to 9). In some embodiments, the aqueous composition can have a pH of from 4 to 9. In some embodiments, the aqueous composition can have a pH of from 5 to 8. In some embodiments, the aqueous composition can have a pH of from 4 to 8.

In some embodiments, when the gelling agent includes HPAM, the pH of the aqueous composition can vary depending on the crosslinker and the specific HPAM derivative. In some embodiments, when the gelling agent includes HPAM, the pH of the aqueous composition can range from pH of 4 to 9, or from pH of 5 to 8. In some embodiments, the pH can range from pH of 5 to 8.

In some embodiments, the aqueous composition has a pH of at least 9 (e.g., at least 8.5, at least 9, at least 9.5, at least 10, at least 10.5, at least 11, or at least 11.5). In some embodiments, the aqueous composition can have a pH of 12 or less (e.g., 11.5 or less, 11 or less, 10.5 or less, 10 or less, 9.5 or less, 9 or less, or 8.5 or less).

The aqueous composition can have a pH ranging from any of the minimum values described above to any of the maximum values described above. For example, in some embodiments, the aqueous composition can have a pH of from 9 to 12 (e.g., from 9.5 to 12, from 9.5 to 11.5, from 9 to 11.5, from 9.5 to 11, from 9 to 11, from 10 to 12, from 10 to 11.5, from 10 to 11, from 11 to 11.5, from 11 to 12, or from 11.5 to 12).

In some embodiments, when the gelling agent includes a biopolymer, for example a polysaccharide such as guar, hydroxypropyl guar (HPG), carboxymethyl hydroxypropyl guar (CMHPG), xanthan, or a blend or copolymer thereof, and the crosslinker is chosen from borates, zirconates, titanates, and combinations thereof, the pH of the aqueous composition can range from pH of from 9 to 12.

In some embodiments, the aqueous composition can further include a proppant. In some embodiments, the proppant can have a wider particle size distribution in order to further enhance aqueous composition flow resistance in the far-field. In some embodiments, the proppant has a particle size of 140 mesh or less (e.g., 120 mesh or less, 100 mesh or less, 80 mesh or less, 60 mesh or less, 40 mesh or less, or 20 mesh or less). In some embodiments, the proppant has a particle size of from 20 to 625 mesh size (e.g, from 40 to 140 mesh size, or from 140 to 625 mesh size). In some embodiments, the proppant can be a micro-proppant. In some embodiments, the micro-proppant can have a particle size of from 140 to 625 mesh size (e.g., from 140 mesh to 600 mesh, from 140 mesh to 500 mesh, from 140 mesh to 250 mesh, from 140 mesh to 200 mesh, from 200 mesh to 625 mesh, from 200 mesh to 500 mesh, from 200 mesh to 400 mesh, from 200 mesh to 300 mesh, from 300 mesh to 625 mesh, from 300 mesh to 500 mesh, from 300 mesh to 400 mesh, from 400 mesh to 625 mesh, from 400 mesh to 500 mesh, or from 500 mesh to 625 mesh).

In some embodiments, the aqueous composition can further include one or more of an acid, an alkali agent, polymer, a biocide, a scale inhibitor, a pH adjusting agent, a non-emulsifier agent, an iron control agent, a chelating agent, a corrosion inhibitor, a clay stabilizing agent, a wettability alteration chemical, an anti-foam agent (e.g., chemical defoamer), a sulfide scavenger, a mobility control agent, a co-solvent, a surfactant, a surfactant package, or any combination thereof.

Described herein are also methods including injecting an aqueous composition comprising a gelling agent and a crosslinker into at least one fracture present in a subterranean formation via a wellbore in fluid communication with the subterranean formation; displacing the gelling agent and the crosslinker to a desired location within the at least one fracture present in the subterranean formation; and optionally exposing the aqueous composition to an external trigger, thereby crosslinking the gelling agent within the at least one fracture. In some embodiments, crosslinking of the gelling agent within the aqueous composition can be a delayed crosslinking. In some embodiment, crosslinking can be delayed by chemical delay agents. In some embodiments, chemical delay agents can interact with the crosslinker to delay crosslinking with the gelling agent. In some embodiments, the aqueous composition can further include a chemical delay agent such as organic complexing agents/metal chelating agents (e.g., citrate, EDTA, lactate, acetate, citrate, NTA, HEDTA, or DTPA). In some embodiments, the crosslinker can be encapsulated. In some embodiments, the crosslinker can be unencapsulated. In some embodiments, exposure of the crosslinker to an external trigger could be delayed by chemical delay agents interacting with the crosslinker to delay crosslinking with the gelling agent. In some embodiments, delayed crosslinking can be accelerated upon exposure of the aqueous composition or crosslinker to an external trigger, thereby crosslinking the gelling agent. In some embodiments, delayed activation of crosslinking could apply to crosslinkers such as borates and metal crosslinkers. In some embodiments, crosslinking of the gelling agent within the aqueous composition can occur upon optional exposure of the aqueous composition to an external trigger such as a change in pH, pressure, temperature, or salinity. In some embodiments, the external trigger can be a change in temperature (e.g., exposure to elevated temperature (e.g., from 75° F. to 350° F.) for an extended exposure time).

Controlled activation of crosslink can bring multiple benefits to the overall fracture procedure. Delay of the crosslink reaction to some point below the surface during frac procedure will first reduce the friction experienced during transit to the target zone, reducing overall friction losses. Delay of the crosslink reaction may limit possible shear degradation of a crosslinked gel that may be experienced before the portions of the fracture where the fracture containment action of the gelled fluid is required.

### Acids

In some embodiments, the aqueous composition can include an acid (e.g., at least 10% acid, such as from 10% to 20% by weight acid). The acid can include any suitable acid known in the art. In some embodiments, the acid can include a strong acid, such as HCl, HF, or any combination thereof. In other embodiments, the acid can include a weak acid, such as an organic acid (e.g., acetic acid, citric acid, tartric acid, or any combination thereof).

### Alkali Agents

In some embodiments, the aqueous composition can include an alkali agent. The term “alkali agent” is used herein according to its conventional meaning and includes basic, ionic salts of alkali metals or alkaline earth metals. Alkali agents as provided herein can be capable of reacting with an unrefined petroleum acid (e.g., an acid in crude oil (reactive oil)) to form soap (a surfactant salt of a fatty acid) in situ. These in situ generated soaps serve as a source of surfactants capable of reducing the interfacial tension of hydrocarbons with an aqueous composition. Examples of suitable alkali agents include, but are not limited to, sodium hydroxide, potassium hydroxide, sodium carbonate, potassium carbonate, sodium silicate, sodium metaborate, and salts of EDTA (e.g., EDTA tetrasodium salt or EDTA tetrapotassium salt). In one embodiment, the alkali agent is NaOH. In other embodiments, the alkali agent is Na₂CO₃.

### Polymers

In some embodiments, the aqueous composition can further include a polymer. Examples of polymer are known in the art. Examples of suitable polymers include biopolymers such as polysaccharides. For example, polysaccharides can be xanthan gum, scleroglucan, guar gum, a mixture thereof (e.g., any modifications thereof such as a modified chain), etc. Indeed, the terminology “mixtures thereof” or “combinations thereof” can include “modifications thereof” herein.

In some embodiments, the aqueous composition includes one or more synthetic (co) polymers, such as one or more acrylamide containing (co) polymers. As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. A polymer may be a “homopolymer” comprising substantially identical recurring units formed by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units. The term “polymer” as used herein is intended to include both the acid form of the polymer as well as its various salts.

In some embodiments, the one or more synthetic (co) polymers can be a polymer useful for enhanced oil recovery applications. The term “enhanced oil recovery” or “EOR” (also known as tertiary oil recovery), refers to a process for hydrocarbon production in which an aqueous composition comprising at least a water soluble polymer is injected into a hydrocarbon bearing formation.

In some embodiments, the one or more synthetic (co) polymers comprise water-soluble synthetic (co) polymers. Examples of suitable synthetic (co) polymers include acrylic polymers, such as polyacrylic acids, polyacrylic acid esters, partly hydrolyzed acrylic esters, substituted polyacrylic acids such as polymethacrylic acid and polymethacrylic acid esters, polyacrylamides, partly hydrolyzed polyacrylamides, and polyacrylamide derivatives such as acrylamide tertiary butyl sulfonic acid (ATBS); copolymers of unsaturated carboxylic acids, such as acrylic acid or methacrylic acid, with olefins such as ethylene, propylene and butylene and their oxides; polymers of unsaturated dibasic acids and anhydrides such as maleic anhydride; vinyl polymers, such as polyvinyl alcohol (PVA), N-vinylpyrrolidone, and polystyrene sulfonate; and copolymers thereof, such as copolymers of these polymers with monomers such as ethylene, propylene, styrene, methylstyrene, and alkylene oxides. In some embodiments, the one or more synthetic (co) polymer can comprise polyacrylic acid (PAA), polyacrylamide (PAM), acrylamide tertiary butyl sulfonic acid (ATBS) (or AMPS, 2-acrylamido-2-methylpropane sulfonic acid), N-vinylpyrrolidone (NVP), polyvinyl alcohol (PVA), or a blend or copolymer of any of these polymers. Copolymers may be made of any combination above, for example, a combination of NVP and ATBS. In certain examples, the one or more synthetic (co) polymers can comprise acrylamide tertiary butyl sulfonic acid (ATBS) (or AMPS, 2-acrylamido-2-methylpropane sulfonic acid) or a copolymer thereof.

In some embodiments, the one or more synthetic (co) polymers can comprise acrylamide (co) polymers. In some embodiments, the one or more acrylamide (co) polymers comprise water-soluble acrylamide (co) polymers. In various embodiments, the acrylamide (co) polymers comprise at least 30% by weight, or at least 50% by weight acrylamide units with respect to the total amount of all monomeric units in the (co) polymer.

Optionally, the acrylamide-(co) polymers can comprise, besides acrylamide, at least one additional co-monomer. In example embodiments, the acrylamide-(co) polymer may comprise less than about 50%, or less than about 40%, or less than about 30%, or less than about 20% by weight of the at least one additional co-monomer. In some embodiments, the additional comonomer can be a water-soluble, ethylenically unsaturated, in particular monoethylenically unsaturated, comonomer. Suitable additional water-soluble comonomers include comonomers that are miscible with water in any ratio, but it is sufficient that the monomers dissolve sufficiently in an aqueous phase to copolymerize with acrylamide. In some cases, the solubility of such additional monomers in water at room temperature can be at least 50 g/L (e.g., at least 150 g/L, or at least 250 g/L).

Other suitable water-soluble comonomers can comprise one or more hydrophilic groups. The hydrophilic groups can be, for example, functional groups that comprise one or more atoms selected from the group of O-, N-, S-, and P-atoms. Examples of such functional groups include carbonyl groups >C—O, ether groups —O—, in particular polyethylene oxide groups —(CH₂—CH₂—O—)ₙ—, where n is preferably a number from 1 to 200, hydroxy groups —OH, ester groups —C(O)O—, primary, secondary or tertiary amino groups, ammonium groups, amide groups —C(O)—NH— or acid groups such as carboxyl groups —COOH, sulfonic acid groups —SO₃H, phosphonic acid groups —PO₃H₂ or phosphoric acid groups —OP(OH)₃.

Examples of monoethylenically unsaturated comonomers comprising acid groups include monomers comprising-COOH groups, such as acrylic acid or methacrylic acid, crotonic acid, itaconic acid, maleic acid or fumaric acid, monomers comprising sulfonic acid groups, such as vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid, or monomers comprising phosphonic acid groups, such as vinylphosphonic acid, allylphosphonic acid, N-(meth)acrylamidoalkylphosphonic acids or (meth)acryloyloxyalkyl-phosphonic acids. Of course the monomers may be used as salts.

The —COOH groups in polyacrylamide-copolymers may not only be obtained by copolymerizing acrylic amide and monomers comprising —COOH groups but also by hydrolyzing derivatives of —COOH groups after polymerization. For example, the amide groups —CO—NH₂ of acrylamide may hydrolyze thus yielding —COOH groups.

Also to be mentioned are derivatives of acrylamide thereof, such as, for example, N-methyl(meth)acrylamide, N,N′-dimethyl(meth)acrylamide, and N-methylolacrylamide, N-vinyl derivatives such as N-vinylformamide, N-vinylacetamide, N-vinylpyrrolidone or N-vinylcaprolactam, and vinyl esters, such as vinyl formate or vinyl acetate. N-vinyl derivatives can be hydrolyzed after polymerization to vinylamine units, vinyl esters to vinyl alcohol units.

Other example comonomers include monomers comprising hydroxy and/or ether groups, such as, for example, hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates.

Other example comonomers are monomers having ammonium groups, i.e monomers having cationic groups. Examples comprise salts of 3-trimethylammonium propylacrylamides or 2-trimethylammonium ethyl(meth)acrylates, for example the corresponding chlorides, such as 3-trimethylammonium propylacrylamide chloride (DIMAPAQUAT) and 2-trimethylammonium ethyl methacrylate chloride (MADAME-QUAT).

Other example monoethylenically unsaturated monomers include monomers which may cause hydrophobic association of the (co) polymers. Such monomers comprise besides the ethylenic group and a hydrophilic part also a hydrophobic part. Such monomers are disclosed for instance in WO 2012/069477, which is incorporated herein by reference in its entirety.

Other example comonomers include N-alkyl acrylamides and N-alkyl quaternary acrylamides, where the alkyl group comprises, for example, a C2-C28 alkyl group.

In certain embodiments, each of the one or more acrylamide-(co) polymers can optionally comprise crosslinking monomers, i.e. monomers comprising more than one polymerizable group. In certain embodiments, the one or more acrylamide-(co) polymers may optionally comprise crosslinking monomers in an amount of less than 0.5%, or 0.1%, by weight, based on the amount of all monomers.

In an embodiment, each of the one or more acrylamide-(co) polymers comprises at least one monoethylenically unsaturated comonomer comprising acid groups, for example monomers which comprise at least one group selected from —COOH, —SO₃H or —PO₃H₂. Examples of such monomers include but are not limited to acrylic acid, methacrylic acid, vinylsulfonic acid, allylsulfonic acid or 2-acrylamido-2-methylpropanesulfonic acid, particularly preferably acrylic acid and/or 2-acrylamido-2-methylpropanesulfonic acid and most preferred acrylic acid or the salts thereof. The amount of such comonomers comprising acid groups can be from 0.1% to 70%, from 1% to 50%, or from 10% to 50% by weight based on the amount of all monomers.

In an embodiment, each of the one or more acrylamide-(co) polymers comprise from 50% to 90% by weight of acrylamide units and from 10% to 50% by weight of acrylic acid units and/or their respective salts, based on the total weight of all the monomers making up the copolymer. In an embodiment, each of the one or more acrylamide-(co) polymers comprise from 60% to 80% by weight of acrylamide units and from 20% to 40% by weight of acrylic acid units, based on the total weight of all the monomers making up the copolymer.

In some embodiments, the one or more synthetic (co) polymers (e.g., the one or more acrylamide (co) polymers) are in the form of particles, which are dispersed in the solution. In some embodiments, the particles of the one or more synthetic (co) polymers can have an average particle size of from 0.4 μm to 5 μm, or from 0.5 μm to 2 μm. Average particle size refers to the d₅₀ value of the particle size distribution (number average) as measured by laser diffraction analysis.

In some embodiments, the one or more synthetic (co) polymers (e.g., the one or more acrylamide (co) polymers) can have a weight average molecular weight (Mw) of from 5,000,000 g/mol to 30,000,000 g/mol; from 10,000,000 g/mol to 25,000,000 g/mol; or from 15,000,000 g/mol to 25,000,000 g/mol.

In some embodiments, the polymer can be present in the aqueous composition in an amount of at least 0.003% by weight (e.g. at least 0.01% by weight, at least 0.05% by weight, at least 0.1% by weight, at least 0.5% by weight, at least 1% by weight, at least 5% by weight, at least 10% by weight, at least 15% by weight, or at least 20% by weight) of the total weight of the aqueous composition. In some embodiments, the polymer can be present in the aqueous composition in an amount of 25% by weight or less, (e.g., 20% by weight or less, 15% by weight or less, 10% by weight or less, 5% by weight or less, 1% by weight or less, 0.5% by weight or less, 0.1% by weight or less, 0.05% by weight or less, or 0.01% by weight or less) of the total weight of the aqueous composition.

The polymer can be present in the aqueous composition in an amount ranging from any of the minimum values described above to any of the maximum values described above. For example, in some embodiments, the polymer can be present in the aqueous composition in an amount of from 0.003% to 25% by weight (e.g. from 0.003% to 10% by weight, from 0.01% to 10% by weight, from 0.01% to 25% by weight, from 0.1% to 25% by weight, from 0.1% to 5% by weight, from 0.1% to 10% by weight, from 0.5% to 25%, from 0.5% to 10% by weight, from 0.5% to 5% by weight from 0.5% to 25% by weight, from 1% to 5%, from 1% to 10%, from 1% to 25%, from 5% to 10%, from 5% to 25%, or from 10% to 25%) of the total weight of the aqueous composition.

### Co-Solvents

In some embodiments, the aqueous composition can include a co-solvent. The co-solvent can include any suitable water-miscible solvent. Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or combinations of any two or more co-solvents. In one embodiment, the co-solvent can comprise alkyl ethoxylate (C1-C6)-XEO X=1-30-linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), dimethyl ether, or any combination thereof. Examples of suitable co-solvents are also described in U.S. Pat. No. 10,337,303, which is incorporated by reference herein in its entirety.

In some embodiments, the co-solvent can be present in the aqueous composition in an amount of from 0.1% to 25% by weight (e.g., from 0.1% to 10% by weight, or from 0.5% to 5% by weight) of the total weight of the aqueous composition.

### Surfactants

Suitable surfactants can include one or more anionic surfactant, non-ionic surfactant, cationic surfactant, zwitterionic surfactant, or any combination thereof. In some embodiments the surfactant can be a surfactant package.

Suitable surfactant packages can include a primary surfactant and optionally one or more secondary surfactants.

In some cases, the primary surfactant can include an anionic surfactant. In these cases, one or more secondary surfactants can include one or more non-ionic surfactants, one or more additional anionic surfactants, one or more cationic surfactants, one or more zwitterionic surfactants, or any combination thereof.

In other cases, the primary surfactant can include a non-ionic surfactant. In these cases, one or more secondary surfactants can include one or more additional non-ionic surfactants, one or more anionic surfactants, one or more cationic surfactants, one or more zwitterionic surfactants, or any combination thereof.

In other cases, the primary surfactant can include a cationic surfactant. In these cases, one or more secondary surfactants can include one or more non-ionic surfactants, one or more anionic surfactants, one or more additional cationic surfactants, one or more zwitterionic surfactants, or any combination thereof.

In other cases, the primary surfactant can include a zwitterionic surfactant. In these cases, one or more secondary surfactants can include one or more non-ionic surfactants, one or more anionic surfactants, one or more cationic surfactants, one or more additional zwitterionic surfactants, or any combination thereof.

In some embodiments, the primary surfactant can include at least 10% by weight (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, or at least 85% by weight) of the aqueous composition, based on the total weight of the aqueous composition. In some embodiments, the primary surfactant can include 90% by weight or less (e.g., 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, or 15% by weight or less) of the aqueous composition, based on the total weight of the aqueous composition.

The primary surfactant can be present in the aqueous composition in an amount ranging from any of the minimum values described above to any of the maximum values described above. For example, in some embodiments, the primary surfactant can include from 10% to 90% by weight (e.g., from 10% to 50% by weight) of the aqueous composition, based on the total weight of the aqueous composition.

In some embodiments, the one or more secondary surfactants can include at least 10% by weight (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, or at least 85% by weight) of the aqueous composition, based on the total weight of the aqueous composition. In some embodiments, the one or more secondary surfactants can include 90% by weight or less (e.g., 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, or 15% by weight or less) of the aqueous composition, based on the total weight of the aqueous composition.

The one or more secondary surfactants can be present in the aqueous composition in an amount ranging from any of the minimum values described above to any of the maximum values described above. For example, in some embodiments, the one or more secondary surfactants can include from 10% to 90% by weight (e.g., from 10% to 50% by weight) of the aqueous composition, based on the total weight of the aqueous composition.

In some embodiments, the aqueous composition can include an anionic surfactant. In other embodiments, the aqueous composition can consist essentially of an anionic surfactant (i.e., the anionic surfactant is the only surfactant present in the aqueous composition). In other embodiments, the aqueous composition can consist of an anionic surfactant. In some of these embodiments, the aqueous composition further includes water. In some of these embodiments, the aqueous composition does not include a hydrocarbon.

In some embodiments, the aqueous composition can include an anionic surfactant and a non-ionic surfactant. In other embodiments, the aqueous composition can consist essentially of an anionic surfactant and a non-ionic surfactant (i.e., the anionic surfactant and the non-ionic surfactant are the only surfactants present in the aqueous composition). In other embodiments, the aqueous composition can consist of an anionic surfactant and a non-ionic surfactant. In some of these embodiments, the aqueous composition can further include water. In some of these embodiments, the aqueous composition does not include a hydrocarbon.

In some embodiments, the aqueous composition can include an anionic surfactant, a second anionic surfactant, and a non-ionic surfactant. In other embodiments, the aqueous composition can consist essentially of an anionic surfactant, a second anionic surfactant, and a non-ionic surfactant (i.e., the anionic surfactant, the second anionic surfactant, and the non-ionic surfactant are the only surfactants present in the aqueous composition). In other embodiments, the aqueous composition can consist of an anionic surfactant, a second anionic surfactant, and a non-ionic surfactant. In some of these embodiments, the aqueous composition further includes water. In some of these embodiments, the aqueous composition does not include a hydrocarbon.

In some embodiments, the aqueous composition can include a non-ionic surfactant. In other embodiments, the aqueous composition can consist essentially of a non-ionic surfactant (i.e., the non-ionic surfactant is the only surfactant present in the aqueous composition). In other embodiments, the aqueous composition can consist of a non-ionic surfactant. In some of these embodiments, the aqueous composition further includes water. In some of these embodiments, the aqueous composition does not include a hydrocarbon.

In some embodiments, the aqueous composition can include a non-ionic surfactant, an anionic surfactant, and a second anionic surfactant. In other embodiments, the aqueous composition can consist essentially of a non-ionic surfactant, an anionic surfactant, and a second anionic surfactant (i.e., the anionic surfactant, the second anionic surfactant, and the non-ionic surfactant are the only surfactants present in the aqueous composition). In other embodiments, the aqueous composition can consist of a non-ionic surfactant, an anionic surfactant, and a second anionic surfactant. In some of these embodiments, the aqueous composition further includes water. In some of these embodiments, the aqueous composition does not include a hydrocarbon.

Suitable anionic surfactants for use as a primary surfactant and/or a secondary surfactant include a hydrophobic tail that includes from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that includes a number of carbon atoms ranging from any of the minimum values described above to any of the maximum values described above. For example, in some embodiments, the anionic surfactant can include a hydrophobic tail including from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may include single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can include, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some embodiments, the anionic surfactant can include, for example a sulfonate, a disulfonate, a sulfate, a disulfate, a sulfosuccinate, a disulfosuccinate, a carboxylate, a dicarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide(di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can include an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (e.g., —CH₂—CH(ethyl)-O—, —CH₂—CH(methyl)-O—, or —CH₂—CH₂—O—) which, in turn is attached to —COO or acid or salt thereof including metal cations such as sodium. In embodiments, the alkoxy carboxylate surfactant can be defined by the formulae below:

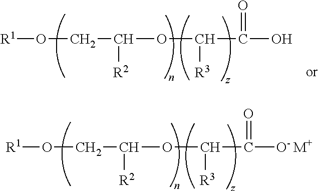

wherein R¹ is substituted or unsubstituted C6-C36 alkyl or substituted or unsubstituted aryl; R² is, independently for each occurrence within the compound, hydrogen or unsubstituted C₁-C₆ alkyl; R³ is independently hydrogen or unsubstituted C₁-C₆ alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH₂—CH(methyl)-O-linkers), attached in turn to from 0 to 100 ethyleneoxy groups (—CH₂—CH₂—O-linkers), attached in turn to —COO⁻ or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (e.g., —CH₂—CH(ethyl)-O—, —CH₂—CH(methyl)-O—, or —CH₂—CH₂—O—) which, in turn is attached to —SO₃ or acid or salt thereof including metal cations such as sodium. In some embodiment, the alkoxy sulfate surfactant has the formula R-(BO)ₑ-(PO)_{f}-(EO)_{g}-SO₃ or acid or salt (including metal cations such as sodium) thereof, wherein R is C6-C32 alkyl, BO is —CH₂—CH(ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (e.g., —CH₂—CH(ethyl)-O—, —CH₂—CH(methyl)-O—, or —CH₂—CH₂—O—) which, in turn is attached to —SO₃ or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO₃ or acid or salt thereof including metal cations such as sodium.

An “aryl sulfate surfactant” or “aryl sulfate” refers to a compound having an aryl group attached to —O—SO₃ or acid or salt thereof including metal cations such as sodium. An “aryl sulfonate surfactant” or “aryl sulfonate” refers to a compound having an aryl group attached to —SO₃ or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO₃ group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the package when the aqueous composition is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication No. 2009/0112014, and SPE 129766, all incorporated herein by reference.

In some embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In some embodiments, the anionic surfactant can be an alkylbenzene sulfonate or a dibenzene disufonate. In some embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In some embodiments, the anionic surfactant can be an isomerized olefin sulfonate (C6-C30), internal olefin sulfonate (C6-C30) or internal olefin disulfonate (C6-C30). In some embodiments, the anionic surfactant is a Guerbet-PO(0-65)-EO(0-100) sulfate (Guerbet portion can be C6-C36). In some embodiments, the anionic surfactant can be a Guerbet-PO(0-65)-EO(0-100) carboxylate (Guerbet portion can be C6-C36). In some embodiments, the anionic surfactant can be alkyl PO(0-65) and EO(0-100) sulfonate: where the alkyl group is linear or branched C6-C36. In some embodiments, the anionic surfactant can be a sulfosuccinate, such as a dialkylsulfosuccinate. In some embodiments, the anionic surfactant can be an alkyl aryl sulfonate (AAS) (e.g., an alkyl benzene sulfonate (ABS)), a C10-C30 internal olefin sulfate (IOS), a petroleum sulfonate, or an alkyl diphenyl oxide(di)sulfonate.

In some examples, the anionic surfactant can include a surfactant defined by the formula below:

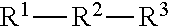

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof; and R³ comprises a branched or unbranched hydrocarbon chain comprising 2-12 carbon atoms and from 2 to 5 carboxylate groups.

In some examples, the anionic surfactant can include a surfactant defined by the formula below:

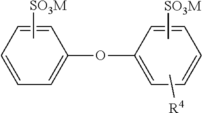

wherein R⁴ is a branched or unbranched, saturated or unsaturated, cyclic or non-cyclic, hydrophobic carbon chain having 6-32 carbon atoms; and M represents a counterion (e.g., Na⁺, K⁺). In some embodiments, R⁴ is a branched or unbranched, saturated or unsaturated, cyclic or non-cyclic, hydrophobic carbon chain having 6-16 carbon atoms.

Suitable non-ionic surfactants for use as a primary surfactant and/or a secondary surfactant include compounds that can be added to increase wettability. In some embodiments, the hydrophilic-lipophilic balance (HLB) of the non-ionic surfactant is greater than 10 (e.g., greater than 9, greater than 8, or greater than 7). In some embodiments, the HLB of the non-ionic surfactant can be from 7 to 10.

The non-ionic surfactant can include a hydrophobic tail comprising from 6 to 60 carbon atoms. In some embodiments, the non-ionic surfactant can include a hydrophobic tail that includes at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, in some embodiments, the non-ionic surfactant can include a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. In some cases, the hydrophobic tail may be a straight chain, branched chain, and/or may comprise cyclic structures. The hydrophobic carbon tail may include single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 Eos. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could comprise 10EO:5PO or 5EO. In embodiments, the non-ionic surfactant may be a mix of surfactants with different length lipophilic tail chain lengths. For example, the non-ionic surfactant may be C9-C11:PO₉:EO2, which indicates a mixture of non-ionic surfactants that have a lipophilic tail length of 9 carbon to 11 carbon, which is followed by a chain of 9 Pos and 2 Eos. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some examples, the non-ionic surfactant can comprise a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), or any combination thereof). In some embodiments, the non-ionic surfactant is one or more alkyl polyglucosides.

Example cationic surfactants include surfactant analogous to those described above, except bearing primary, secondary, or tertiary amines, or quaternary ammonium cations, as a hydrophilic head group. “Zwitterionic” or “zwitterion” as used herein refers to a neutral molecule with a positive (or cationic) and a negative (or anionic) electrical charge at different locations within the same molecule. Example zwitterionic surfactants include betains and sultains.

Examples of suitable surfactants are disclosed, for example, in U.S. Pat. Nos. 3,811,504, 3,811,505, 3,811,507, 3,890,239, 4,463,806, 6,022,843, 6,225,267, 7,629,299, 7,770,641, 9,976,072, 8,211, 837, 9,422,469, 9,605,198, 8,822,391, 9,783,729, 8,372,788, and 9,617,464; WIPO Patent Application Nos. WO/2008/079855; as well as U.S. Patent Application Publication Nos. 2005/0199395, 2006/0185845, 2006/0189486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2017/0198202, each of which is hereby incorporated by reference herein in its entirety for its description of example surfactants.

In some embodiments, the primary surfactant can have a concentration within the aqueous composition of at least 0.01% by weight (e.g., at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, or at least 2.25% by weight), based on the total weight of the aqueous composition. In some embodiments, the primary surfactant can have a concentration within the aqueous composition of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous composition. In particular embodiments, the primary surfactant can have a concentration within the aqueous composition of less than 1%, less than 0.5%, less than 0.2%, less than 0.1%, less than 0.075%, or less than 0.05%.

The primary surfactant can have a concentration within the aqueous composition ranging from any of the minimum values described above to any of the maximum values described above. For example, in some embodiments, the primary surfactant can have a concentration within the aqueous composition of from 0.01% to 2.5% by weight (e.g., from 0.05% to 0.5% by weight), based on the total weight of the aqueous composition.

When present, the one or more secondary surfactants can have a concentration within the aqueous composition of at least 0.001% by weight (e.g., at least 0.005% by weight, at least 0.01% by weight, at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, or at least 2.25% by weight), based on the total weight of the aqueous composition. In some embodiments, the one or more secondary surfactants can have a concentration within the aqueous composition of 2.5% by weight or less (e.g., 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, 0.02% by weight or less, 0.01% by weight or less, or 0.005% by weight or less), based on the total weight of the aqueous composition. In particular embodiments, the one or more secondary surfactants can have a concentration within the aqueous composition of less than 2%, less than 1.5%, less than 1%, less than 0.5%, less than 0.2%, less than 0.1%, less than 0.075%, less than 0.05%, or less than 0.01%.

When present, the one or more secondary surfactants can have a concentration within the aqueous composition ranging from any of the minimum values described above to any of the maximum values described above. For example, in some embodiments, the one or more secondary surfactants can have a concentration within the aqueous composition of from 0.001% to 2.5% by weight (e.g., from 0.001% to 1.5% by weight, or from 0.05% to 0.5% by weight), based on the total weight of the aqueous composition.

In some embodiments, the primary surfactant and one or more secondary surfactants can be present in the aqueous composition at a weight ratio of primary surfactant to one or more secondary surfactants of at least 1:1 (e.g., at least 2:1, at least 2.5:1, at least 3:1, at least 4:1, at least 5:1, at least 6:1, at least 7:1, at least 8:1, or at least 9:1). In some embodiments, the primary surfactant and one or more secondary surfactants can be present in the aqueous composition in a weight ratio of primary surfactant to one or more secondary surfactants of 10:1 or less (e.g., 9:1 or less; 8:1 or less, 7:1 or less, 6:1 or less, 5:1 or less, 4:1 or less, 3:1 or less, 2.5:1 or less, or 2:1 or less).

The primary surfactant and one or more secondary surfactants can be present in the aqueous composition in a weight ratio ranging from any of the minimum values described above to any of the maximum values described above. For example, the primary surfactant and one or more secondary surfactants can be present in the aqueous composition in a weight ratio of primary surfactant to one or more secondary surfactants of from 1:1 to 10:1 (e.g., 1:1 to 5:1).

In other embodiments, the one or more secondary surfactants are absent (i.e., the primary surfactant is the only surfactant present in the aqueous composition).

In some embodiments, the total concentration of all surfactants in the aqueous composition (the total concentration of the primary surfactant and the one or more secondary surfactants in the aqueous composition) can be at least 0.01% by weight (e.g., at least 0.02% by weight, at least 0.03% by weight, at least 0.04% by weight, at least 0.05% by weight, at least 0.06% by weight, at least 0.07% by weight, at least 0.08% by weight, at least 0.09% by weight, at least 0.1% by weight, at least 0.15% by weight, at least 0.2% by weight, at least 0.25% by weight, at least 0.3% by weight, at least 0.35% by weight, at least 0.4% by weight, at least 0.45% by weight, at least 0.5% by weight, at least 0.55% by weight, at least 0.6% by weight, at least 0.65% by weight, at least 0.7% by weight, at least 0.75% by weight, at least 0.8% by weight, at least 0.85% by weight, at least 0.9% by weight, at least 0.95% by weight, at least 1% by weight, at least 1.25% by weight, at least 1.5% by weight, at least 1.75% by weight, at least 2% by weight, at least 2.25% by weight, at least 2.5% by weight, at least 2.75% by weight, at least 3% by weight, at least 3.25% by weight, at least 3.5% by weight, at least 3.75% by weight, at least 4% by weight, at least 4.25% by weight, at least 4.5% by weight, or at least 4.75% by weight), based on the total weight of the aqueous composition. In some embodiments, the total concentration of all surfactants in the aqueous composition (the total concentration of the primary surfactant and the one or more secondary surfactants in the aqueous composition) can be 5% by weight or less (e.g., 4.75% by weight or less, 4.5% by weight or less, 4.25% by weight or less, 4% by weight or less, 3.75% by weight or less, 3.5% by weight or less, 3.25% by weight or less, 3% by weight or less, 2.75% by weight or less, 2.5% by weight or less, 2.25% by weight or less, 2% by weight or less, 1.75% by weight or less, 1.5% by weight or less, 1.25% by weight or less, 1% by weight or less, 0.95% by weight or less, 0.9% by weight or less, 0.85% by weight or less, 0.8% by weight or less, 0.75% by weight or less, 0.7% by weight or less, 0.65% by weight or less, 0.6% by weight or less, 0.55% by weight or less, 0.5% by weight or less, 0.45% by weight or less, 0.4% by weight or less, 0.35% by weight or less, 0.3% by weight or less, 0.25% by weight or less, 0.2% by weight or less, 0.15% by weight or less, 0.1% by weight or less, 0.09% by weight or less, 0.08% by weight or less, 0.07% by weight or less, 0.06% by weight or less, 0.05% by weight or less, 0.04% by weight or less, 0.03% by weight or less, or 0.02% by weight or less), based on the total weight of the aqueous composition.

The total concentration of all surfactants in the aqueous composition (the total concentration of the primary surfactant and the one or more secondary surfactants in the aqueous composition) can range from any of the minimum values described above to any of the maximum values described above. For example, in some embodiments, the total concentration of all surfactants in the aqueous composition (the total concentration of the primary surfactant and the one or more secondary surfactants in the aqueous composition) can be from 0.01% by weight to 5% by weight (e.g., from 0.01% to 2.5% by weight, from 0.01% to 1% by weight, or from 0.01% to 0.5% by weight).

In some embodiments when the aqueous composition is being injected into a horizontal well, the total concentration of all surfactants in the aqueous composition (the total concentration of the primary surfactant and the one or more secondary surfactants in the aqueous composition) can be from 0.01% to 1.5% by weight, from 0.01% to 1% by weight, or from 0.01% to 0.5% by weight.

In some embodiments when the aqueous composition is being injected into a vertical well, the total concentration of all surfactants in the aqueous composition (the total concentration of the primary surfactant and the one or more secondary surfactants in the aqueous composition) can be from 0.01% to 5% by weight, from 0.01% to 1% by weight, from 0.5% to 5% by weight, from 0.5% to 2.5% by weight, from 0.5% to 1.5% by weight, from 0.5% to 1% by weight, from 1% to 5% by weight, from 1% to 2.5% by weight, or from 1% to 1.5% by weight.

In some embodiments, the aqueous composition can comprise a non-ionic surfactant and an anionic surfactant (e.g., a sulfonate or disulfonate). In some embodiments, the aqueous composition can comprise a non-ionic surfactant and two or more anionic surfactants (e.g., a sulfonate or disulfonate and a carboxylate). In some embodiments, the aqueous composition can comprise a non-ionic surfactant (e.g., a C6-C16 alkyl phenol ethoxylate, or a C6-C16:PO(0-25):EO(0-25), such as a C9-C11 ethoxylated alcohol, a C13 ethoxylated alcohol, a C6-C₁₀ ethoxylated propoxylated alcohol, or a C10-C14 ethoxylated Guerbet alcohol) and a sulfonate surfactant (e.g., a C10-16 disulfonate, or a C16-28 IOS). In some embodiments, the aqueous composition can comprise a non-ionic surfactant (e.g., a C6-C16 alkyl phenol ethoxylate, or a C6-16:PO(0-25):EO(0-25), such as a C9-C11 ethoxylated alcohol, a C13 ethoxylated alcohol, a C6-C₁₀ ethoxylated propoxylated alcohol, or a C10-C14 ethoxylated Guerbet alcohol), a sulfonate surfactant (e.g., a C10-16 disulfonate, or a C16-28 IOS), and a carboxylate surfactant (e.g., a C10-16 alkyl polyglucoside carboxylate or a C22-C36 Guerbet alkoxylated carboxylate).

Specific example surfactant packages are shown in the table below.

| | Surfactants and Co-Surfactants in Surfactant Package |
|---|---|
| Example | (in weight percent) |
| 1 | 0.09% alkoxylated C6-C16 alcohol |
| | 0.06% disulfonate |
| 2 | 0.1% alkoxylated C6-C16 alcohol |
| | 0.1% carboxylate |
| | 0.1% disulfonate |
| 3 | 0.15% alkoxylated C6-C16 alcohol |
| | 0.075% carboxylate |
| | 0.075% disulfonate |
| 4 | 0.2% alkoxylated C6-C16 alcohol |
| | 0.1% carboxylate |
| 5 | 0.2% alkoxylated C6-C16 alcohol |
| | 0.033% carboxylate |
| | 0.066% disulfonate |
| 6 | 0.2% alkoxylated C6-C16 alcohol |
| | 0.033% carboxylate |
| | 0.066% disulfonate |
| 7 | 0.2% alkoxylated C6-C16 alcohol |
| | 0.05% carboxylate |
| | 0.05% olefin sulfonate |
| 8 | 0.15% alkoxylated C6-C16 alcohol |
| | 0.05% carboxylate |
| | 0.05% olefin sulfonate |
| | 0.05% alkyl polyglucoside |
| 9 | 0.1% alkoxylated C6-C16 alcohol |
| | 0.05% carboxylate |
| | 0.05% olefin sulfonate |
| | 0.1% alkyl polyglucoside |
| 10 | 0.15% alkoxylated C6-C16 alcohol |
| | 0.07% carboxylate |
| | 0.03% olefin sulfonate |
| | 0.1% alkyl polyglucoside |
| 11 | 0.1% alkoxylated C6-C16 alcohol |
| | 0.04% carboxylate |
| | 0.05% olefin sulfonate |
| | 0.03% disulfonate |
| | 0.1% alkyl polyglucoside |
| 12 | 0.1% alkoxylated C6-C16 alcohol |
| | 0.04% carboxylate |
| | 0.06% disulfonate |
| | 0.1% alkyl polyglucoside |
| 13 | 0.15% alkoxylated C6-C16 alcohol |
| | 0.15% alkoxylated alkylphenol |
| | 0.1% olefin sulfonate |
| | 0.1% Guerbet alkoxylated carboxylate |
| 14 | 0.125% alkoxylated C6-C16 alcohol |
| | 0.175% alkoxylated alkylphenol |
| | 0.1% olefin sulfonate |
| | 0.1% Guerbet alkoxylated carboxylate |
| 15 | 0.1% alkoxylated C6-C16 alcohol |
| | 0.2% alkoxylated alkylphenol |
| | 0.1% olefin sulfonate |
| | 0.1% Guerbet alkoxylated carboxylate |
| 16 | 0.12% alkoxylated C6-C16 alcohol |
| | 0.22% alkoxylated alkylphenol |
| | 0.08% olefin sulfonate |
| | 0.08% Guerbet alkoxylated carboxylate |
| 17 | 0.15% alkoxylated C6-C16 alcohol |
| | 0.15% alkoxylated alkylphenol |
| | 0.08% olefin sulfonate |
| | 0.06% Guerbet alkoxylated carboxylate |
| | 0.06% carboxylate |
| 18 | 0.15% alkoxylated C6-C16 alcohol |
| | 0.15% alkoxylated alkylphenol |
| | 0.05% olefin sulfonate |
| | 0.1% Guerbet alkoxylated carboxylate |
| | 0.05% disulfonate |
| 19 | 0.5% olefin sulfonate |
| | 0.5% Guerbet alkoxylated carboxylate |
| | 0.55% glycosides or glucosides |
| 20 | 0.5% olefin sulfonate |
| | 0.5% Guerbet alkoxylated carboxylate |
| | 0.5% glycosides or glucosides |
| | 0.25% alkoxylated C6-C16 alcohol |
| 21 | 0.5% olefin sulfonate |
| | 0.5% Guerbet alkoxylated carboxylate |
| | 0.5% glycosides or glucosides |
| | 0.5% alkoxylated C6-C16 alcohol |
| 22 | 0.5% olefin sulfonate |
| | 0.5% Guerbet alkoxylated carboxylate |
| | 1% glycosides or glucosides |
| | 0.5% alkoxylated C6-C16 alcohol |
| 23 | 0.05% olefin sulfonate |
| | 0.05% Guerbet alkoxylated carboxylate |
| | 0.05% glycosides or glucosides |
| | 0.05% alkoxylated C6-C16 alcohol |
| 24 | 0.075% glycosides or glucosides |
| | 0.075% alkoxylated C6-C16 alcohol |
| 25 | 0.1% alkoxylated C6-C16 alcohol |
| | 0.05% disulfonate |
| 26 | 0.1% alkoxylated C6-C16 alcohol |
| | 0.05% disulfonate |
| | 0.03% hydroxyalkyl alkylammonium chloride |
| 27 | 0.03% olefin sulfonate |
| | 0.04% Guerbet alkoxylated carboxylate |
| | 0.08% glycosides or glucosides |
| | 0.05% alkoxylated C6-C16 alcohol |
| 28 | 0.4% olefin sulfonate |
| | 0.4% Guerbet alkoxylated carboxylate |
| | 0.7% glycosides or glucosides |
| | 0.5% alkoxylated C6-C16 alcohol |
| 29 | 0.05% olefin sulfonate |
| | 0.1% glycosides or glucosides |
| | 0.05% alkoxylated C6-C16 alcohol |
| 30 | 0.05% olefin sulfonate |
| | 0.1% alkyl polyglucoside |
| | 0.05% alkoxylated C6-C16 alcohol |
| 31 | 0.05% olefin sulfonate |
| | 0.1% glycosides or glucosides |
| | 0.05% alkoxylated C6-C16 alcohol |
| 32 | 0.05% olefin sulfonate |
| | 0.1% alkyl polyglucoside |
| | 0.05% alkoxylated C6-C16 alcohol |
| 33 | 0.05% olefin sulfonate |
| | 0.1% alkyl polyglucoside |
| | 0.05% alkoxylated C6-C16 alcohol |
| 34 | 0.05% olefin sulfonate |
| | 0.05% glycosides or glucosides |
| | 0.05% alkoxylated C6-C16 alcohol |
| | 0.05% carboxylate |
| 35 | 0.05% olefin sulfonate |
| | 0.05% glycosides or glucosides |
| | 0.05% alkoxylated C6-C16 alcohol |
| | 0.05% carboxylate |
| 36 | 0.05% olefin sulfonate |
| | 0.05% alkyl polyglucoside |
| | 0.05% alkoxylated C6-C16 alcohol |
| 37 | 0.06% olefin sulfonate |
| | 0.05% alkyl polyglucoside |
| | 0.04% alkoxylated C6-C16 alcohol |
| 38 | 0.04% olefin sulfonate |
| | 0.08% glycosides or glucosides |
| | 0.05% alkoxylated C6-C16 alcohol |
| | 0.03% disulfonate |
| 39 | 0.035% olefin sulfonate |
| | 0.075% glycosides or glucosides |
| | 0.05% alkoxylated C6-C16 alcohol |
| | 0.04% disulfonate |
| 40 | 0.035% olefin sulfonate |
| | 0.07% glycosides or glucosides |
| | 0.045% alkoxylated C6-C16 alcohol |
| | 0.05% disulfonate |
| 41 | 0.1% alkoxylated C6-C16 alcohol |
| | 0.1% disulfonate |
| 42 | 0.25% Guerbet alkoxylated carboxylate |
| | 0.25% olefin sulfonate |
| | 0.5% glycosides or glucosides |
| | 0.5% co-solvent |
| 43 | 0.075% alkoxylated C12-C22 alcohol |
| | 0.075% disulfonate |
| 44 | 0.075% alkoxylated C6-C16 Guerbet alcohol |
| | 0.075% disulfonate |
| 45 | 0.075% alkoxylated C12-C22 Guerbet alcohol |
| | 0.075% disulfonate |
| 46 | 0.075% alkoxylated C6-C16 alcohol |
| | 0.075% disulfonate |
| 47 | 0.075% disulfonate |
| | 0.075% alkoxylated C6-C16 alcohol |
| 48 | 0.0625% disulfonate |
| | 0.0875% alkoxylated C6-C16 alcohol |
| 49 | 0.055% disulfonate |
| | 0.095% alkoxylated C6-C16 alcohol |
| 50 | 0.075% disulfonate |
| | 0.075% alkoxylated C6-C16 alcohol |
| 51 | 1% alkoxylated C6-C16 alcohol |
| | 0.5% disulfonate |
| 52 | 1% alkoxylated C6-C16 alcohol |
| 53 | 1% alkoxylated C6-C16 alcohol |
| | 2.25% sulfosuccinate |
| 54 | 0.25% Guerbet alkoxylated carboxylate |
| | 1% alkoxylated C6-C16 alcohol |
| | 2.25% sulfosuccinate |
| 55 | 0.25% Guerbet alkoxylated carboxylate |
| | 1% alkoxylated alkylphenol |
| | 2.25% sulfosuccinate |
| 56 | 0.25% Guerbet alkoxylated carboxylate |
| | 1% alkoxylated C6-C16 alcohol |
| 57 | 0.25 Guerbet alkoxylated carboxylate |
| | 1% alkoxylated alkylphenol |
| 58 | 0.65% carboxylate |
| | 0.35% alkoxylated C6-C16 alcohol |
| 59 | 0.325% carboxylate |
| | 0.925% alkoxylated C6-C16 alcohol |
| 60 | 0.25% olefin sulfonate |
| | 1.0% alkoxylated C6-C16 alcohol |
| 61 | 0.15% olefin sulfonate |
| | 0.2% Guerbet alkoxylated carboxylate |
| | 0.92% carboxylate |
| 62 | 0.65% carboxylate |
| | 0.35% second carboxylate |
| 63 | 0.65% carboxylate |
| | 0.35% alkoxylated C6-C16 alcohol |
| | 1% olefin sulfonate |
| 64 | 1% alkoxylated alcohol |
| | 1% olefin sulfonate |
| 65 | 0.5% alkoxylated alcohol |
| | 0.5% olefin sulfonate |
| | 0.25% carboxylate |
| 66 | 0.6% co-solvent |
| | 0.6% olefin sulfonate |
| 67 | 0.6% co-solvent |
| | 0.3% disulfonate |
| | 0.3% olefin sulfonate |
| 68 | 0.6% Guerbet alkoxylated carboxylate |
| | 0.6% disulfonate |
| 69 | 0.6% co-solvent |
| | 0.4% disulfonate |
| | 0.2% olefin sulfonate |
| 70 | 0.5% alkoxylated C6-C16 alcohol |
| | 0.4% disulfonate |
| | 0.3% olefin sulfonate |
| 71 | 1% alkoxylated C6-C16 alcohol |
| 72 | 0.9% alkoxylated C6-C16 alcohol |
| | 0.6% disulfonate |
| 73 | 0.4% alkoxylated C6-C16 alcohol |
| | 0.35% disulfonate |
| | 0.25% olefin sulfonate |
| | 0.5% co-solvent |
| 74 | 0.25% Guerbet alkoxylated carboxylate |
| | 0.5% alkoxylated C6-C16 alcohol |
| | 0.35% disulfonate |
| | 0.15% olefin sulfonate |
| | 0.35% co-solvent |
| 75 | 0.25% Guerbet alkoxylated carboxylate |
| | 0.25% alkoxylated C6-C16 alcohol |
| | 0.25% olefin sulfonate |
| | 0.25% co-solvent |
| 76 | 0.25% Guerbet alkoxylated carboxylate |
| | 0.25% alkoxylated C6-C16 alcohol |
| | 0.25% olefin sulfonate |
| | 0.25% alkoxylated alcohol |
| 77 | 0.25% Guerbet alkoxylated carboxylate |
| | 0.35% olefin sulfonate |
| | 0.5% alkoxylated alcohol |
| 78 | 0.25% Guerbet alkoxylated carboxylate |
| | 0.25% alkoxylated C6-C16 alcohol |
| | 0.15% olefin sulfonate |
| | 0.1% disulfonate |
| | 0.25% co-solvent |
| 79 | 0.25% Guerbet alkoxylated carboxylate |
| | 0.25% alkoxylated C6-C16 alcohol |
| | 0.25% olefin sulfonate |
| | 0.25% glycosides or glucosides |
| | 0.25% co-solvent |
| | 0.15% disulfonate |
| 80 | 0.25% Guerbet alkoxylated carboxylate |
| | 0.25% olefin sulfonate |
| | 0.5% glycosides or glucosides |
| | 0.25% co-solvent |
| 81 | 0.15% alkoxylated C12-C22 alcohol |
| 82 | 0.075% disulfonate |
| | 0.075% alkoxylated C12-C22 alcohol |
| 83 | 0.75% alkoxylated C12-C22 alcohol |
| | 0.75% disulfonate |
| 84 | 0.075% alkoxylated C12-C22 alcohol |
| | 0.075% alkoxylated C6-C16 Guerbet alcohol |
| 85 | 0.15% alkoxylated C6-C16 Guerbet alcohol |
| 86 | 0.075% disulfonate |
| | 0.075% alkoxylated C6-C16 Guerbet alcohol |
| 87 | 0.075% alkoxylated C6-C16 Guerbet alcohol |
| | 0.075% disulfonate |
| | 0.05% co-solvent |
| 88 | 0.1% alkoxylated C6-C16 alcohol |
| | 0.05% disulfonate |
| 89 | 1% alkoxylated C6-C16 alcohol |
| | 0.5% disulfonate |
| 90 | 0.075% alkoxylated C6-C16 Guerbet alcohol |
| | 0.075% disulfonate |
| 91 | 0.075% alkoxylated C6-C16 Guerbet alcohol |
| | 0.125% disulfonate |
| 92 | 0.075% alkoxylated C12-C22 alcohol |
| | 0.125% disulfonate |
| 93 | 0.75% disulfonate |
| | 0.75% alkoxylated C12-C22 alcohol |
| 94 | 0.75% alkoxylated C6-C16 Guerbet alcohol |
| | 0.75% disulfonate |
| 95 | 0.1% alkoxylated C6-C16 Guerbet alcohol |
| | 0.05% disulfonate |
| 96 | 0.75% disulfonate |
| | 0.75% alkoxylated C6-C16 Guerbet alcohol |
| 97 | 0.75% alkoxylated C6-C16 alcohol |
| | 0.75% disulfonate |
| 98 | 0.75% disulfonate |
| | 0.75% alkoxylated C6-C16 alcohol |
| 99 | 0.1% alkoxylated C6-C16 alcohol |
| | 0.05% disulfonate |
| 100 | 0.09% alkoxylated C6-C16 alcohol |
| | 0.06% disulfonate |
| 101 | 0.1% alkoxylated C6-C16 alcohol |
| | 0.1% disulfonate |
| | 0.1% Guerbet alkoxylated carboxylate |
| 102 | 0.1% alkoxylated C6-C16 alcohol |
| | 0.1% disulfonate |
| 103 | 0.65% Guerbet alkoxylated carboxylate |
| | 0.35% olefin sulfonate |
| | 0.33% alkoxylated alkylphenol |
| | 0.5% co-solvent |
| | 0.25% second co-solvent |
| 104 | 0.075% alkoxylated C6-C16 alcohol |
| | 0.075% benzenesulfonic acid, decyl(sulfophenoxy)-disodium |
| | salt |
| 105 | 0.15% alkoxylated C6-C16 alcohol |
| | 0.05% benzenesulfonic acid, decyl(sulfophenoxy)-disodium |
| | salt |
| 106 | 0.9% Guerbet alkoxylated carboxylate |
| | 0.9% alkoxylated C6-C16 alcohol |
| | 1.2% olefin sulfonate |
| | 0.225% co-solvent |
| | 2% sodium tetraborate |
| | 1% acetic acid |
| 107 | 1% alkoxylated C6-C16 alcohol |
| | 1% olefin sulfonate |
| | 2% sodium tetraborate |
| | 1% acetic acid |
| 108 | 1% alkoxylated C6-C16 alcohol |
| | 0.75% olefin sulfonate |
| | 0.5% disulfonate |
| | 2% sodium tetraborate |
| | 1% acetic acid |
| 109 | 1% alkoxylated C6-C16 alcohol |
| | 0.75% olefin sulfonate |
| | 0.3% disulfonate |
| | 2% sodium tetraborate |
| | 1% acetic acid |
| 110 | 0.5% alkoxylated C6-C16 alcohol |
| | 0.85% olefin sulfonate |
| | 0.15% disulfonate |
| | 2% sodium tetraborate |
| | 1% acetic acid |
| 111 | 0.9% Guerbet alkoxylated carboxylate |
| | 0.9% alkoxylated C6-C16 alcohol |
| | 1.2% olefin sulfonate |
| | 0.225% co-solvent |
| | 2% sodium tetraborate |
| | 1% citric acid |
| 112 | 1% alkoxylated C6-C16 alcohol |
| | 0.75% olefin sulfonate |
| | 0.3% disulfonate |
| | 2% sodium tetraborate |
| | 1% citric acid |
| 113 | 0.9% Guerbet alkoxylated carboxylate |
| | 0.9% alkoxylated C6-C16 alcohol |
| | 1.2% olefin sulfonate |
| | 0.225% co-solvent |
| | 2% sodium tetraborate |
| | 1.1% citric acid |
| 114 | 0.5% Guerbet alkoxylated carboxylate |
| | 0.25% C6-C16 alcohol alkoxylated carboxylate |
| | 0.5% alkoxylated C6-C16 alcohol |
| | 0.5% olefin sulfonate |
| | 0.1% disulfonate |
| | 0.5% co-solvent |
| | 2% sodium tetraborate |
| | 1% acetic acid |
| 115 | 0.5% C6-C16 alcohol alkoxylated carboxylate |
| | 0.25% alkoxylated C6-C16 alcohol |
| | 0.15% olefin sulfonate |
| | 0.35% disulfonate |
| | 2% sodium tetraborate |
| | 1% acetic acid |
| 116 | 0.5% Guerbet alkoxylated carboxylate |
| | 0.25% C6-C16 alcohol alkoxylated carboxylate |
| | 0.5% alkoxylated C6-C16 alcohol |
| | 0.5% olefin sulfonate |
| | 0.1% disulfonate |
| | 0.5% co-solvent |
| | 0.02% cetyl betaine |
| | 2% sodium tetraborate |
| | 1% acetic acid |
| 117 | 0.075% a first alkoxylated C6-C16 alcohol |
| | 0.075% a second alkoxylated C6-C16 alcohol |
| | 0.125% disulfonate |

In some embodiments, the one or more surfactants in the aqueous composition can decrease the interfacial tension (IFT) of the aqueous composition with hydrocarbons in the reservoir. Reducing the IFT can decrease pressure required to drive the aqueous composition into the formation matrix. In addition, decreasing the IFT reduces water block during production, facilitating the flow of hydrocarbons from the formation to the wellbore (e.g., facilitating the flow of hydrocarbons back through the fractures and to the wellbore). In this way, hydrocarbon recovery can be facilitated by the one or more surfactants in the aqueous composition.

In some embodiments, the one or more surfactants in the aqueous composition can change the wettability of the reservoir. In particular, in embodiments where the reservoir is oil-wet or mixed-wet, the one or more surfactants in the aqueous composition can make the reservoir more water-wet. By increasing the water-wetness of the reservoir, the formation will imbibe injected aqueous composition into the formation matrix, leading to a corresponding flow of hydrocarbon from regions within the formation back to the fractures. In this way, hydrocarbon recovery can be facilitated by the one or more surfactants in the aqueous composition.

### Nanoparticles

In some embodiments, the aqueous composition can include nanoparticles. The nanoparticles can include any of the components of the aqueous composition described herein. For example, the nanoparticles can include a gelling agent. Other examples of suitable nanoparticles are described, for example, in U.S. Pat. No. 10,266,750, which is hereby incorporated by reference in its entirety. In some embodiments, the nanoparticles can be added to enhance the performance of the gelling agent.

### Example Embodiments

Certain example implementations are described in the embodiments below.

Embodiment 1: An aqueous composition comprising:
a gelling agent and an encapsulated crosslinker;
wherein crosslinking of the gelling agent within the aqueous composition occurs upon release of the crosslinker from the encapsulant.

Embodiment 2: The aqueous composition of claim 1, wherein upon crosslinking of the gelling agent, the aqueous composition increases in viscosity by at least one order of magnitude, such as at least two orders of magnitude, or at least three orders of magnitude.

Embodiment 3: The aqueous composition of any one of claims 1-2, wherein upon crosslinking of the gelling agent, the aqueous composition forms a gel.

Embodiment 4: The aqueous composition of any one of claims 1-3, wherein prior to release of the crosslinker from its encapsulant, the aqueous composition has an apparent viscosity of 20 cP or less at 25° C. measured at a shear rate of 170 sec-1, such as 10 cP or less, or 5 cP or less.

Embodiment 5: The aqueous composition of any one of claims 1-4, wherein upon crosslinking of the gelling agent, the aqueous composition has an apparent viscosity of at least 50 cP at 25° C. measured at a shear rate of 170 sec-1, such as at least 100 cP, at least 250 cP, at least 500 cP, at least 1000 cP, at least 1500 cP, or at least 2000 cP.

Embodiment 6: The aqueous composition of any one of claims 1-5, wherein the encapsulated crosslinker comprises a crosslinker at least partially encapsulated within a dissolvable coating.

Embodiment 7: The aqueous composition of claim 6, wherein the dissolvable coating comprises a dissolvable salt, a soluble polymer, or any combination thereof.

Embodiment 8: The aqueous composition of any one of claims 1-6, wherein the encapsulated crosslinker comprises a crosslinker at least partially encapsulated within a frangible coating.

Embodiment 9: The aqueous composition of claim 8, wherein the frangible coating comprises a polymeric coating.

Embodiment 10: The aqueous composition of claim 9, wherein the polymeric coating comprises polyvinylidene chloride (PVDC); a (meth)acrylate polymer, such as a crosslinked (meth)acrylate polymer; a resin, such as a phenolic resin or a urea formaldehyde resin; or a blend or copolymer thereof.

Embodiment 11: The aqueous composition of any one of claims 1-6, wherein the encapsulated crosslinker comprises a crosslinker at least partially encapsulated within a meltable coating.

Embodiment 12: The aqueous composition of any one of claims 1-6, wherein the encapsulated crosslinker comprises a crosslinker at least partially encapsulated within a soft-gel coating.

Embodiment 13: The aqueous composition of any one of claims 1-6, wherein the encapsulated crosslinker comprises a crosslinker at least partially encapsulated within a degradable coating.

Embodiment 14: The aqueous composition of claim 13, wherein the degradable coating degrades in response to an external trigger.

Embodiment 15: The aqueous composition of claim 14, wherein the external trigger comprises a change in pH, pressure, temperature, salinity, mechanical force such as ultrasonic power, or any combination thereof.

Embodiment 16: The aqueous composition of any one of claims 13-15, wherein the degradable coating is acid soluble (e.g., calcium carbonate).

Embodiment 17: The aqueous composition of any one of claims 13-15, wherein the degradable coating is an ultrathin coating shattered by ultrasonic stimulus.

Embodiment 18: The aqueous composition of any one of claims 13-15, wherein the degradable coating comprises swellable polymers that shrink in response to change in salinity.

Embodiment 19: The aqueous composition of any one of claims 1-18, wherein the crosslinker comprises a solid crosslinker.

Embodiment 20: The aqueous composition of any one of claims 1-18, wherein the crosslinker comprises a liquid crosslinker.

Embodiment 21: The aqueous composition of claim 20, wherein the liquid crosslinker is adsorbed to a solid carrier.

Embodiment 22: The aqueous composition of claim 20 or claim 21, wherein the liquid crosslinker is adsorbed to an inert solid carrier.

Embodiment 23: The aqueous composition of any one of claims 1-22, wherein the crosslinker is chosen from organic crosslinkers, aluminates, borates, zirconates, chromates, titanates, and combinations thereof.

Embodiment 24: The aqueous composition of any one of claims 1-23, wherein the gelling agent comprises a polymer.

Embodiment 25: The aqueous composition of claim 24, wherein the polymer is chosen from partially hydrolyzed polyacrylamides (HPAMs or PHPAs), polyacrylamides, polyacrylic acid (PAA), polyvinyl alcohol (PVA), co-polymers of polyacrylamide (PAM), 2-acrylamido 2-methylpropane sulfonic acid (and/or sodium salt) commonly referred to as AMPS (e.i., acrylamido tertiobutyl sulfonic acid or ATBS), N-vinyl pyrrolidone (NVP), guar, hydroxypropyl guar (HPG), carboxymethyl hydroxypropyl guar (CMHPG), and xanthan, or any combination thereof.

Embodiment 26: The aqueous composition of any one of claims 24-25, wherein the polymer is present in the aqueous composition at a concentration of at least 1 lbm/Mgal, such as from 1 lbm/Mgal to 24 lbm/Mgal).

Embodiment 27: The aqueous composition of any one of claims 24-26, wherein the polymer is present in the in the aqueous composition at a concentration of from 0.005% to 0.5% by weight of the aqueous composition (e.g., 0.012% to 0.28% by weight).

Embodiment 28: The aqueous composition of any one of claims 1-27, wherein the aqueous composition comprises slickwater.

Embodiment 29: The aqueous composition of any one of claims 1-28, wherein the gelling agent comprises partially hydrolyzed polyacrylamide (HPAM), polyacrylamide, or a blend or copolymer thereof, and wherein the crosslinker is chosen from aluminates, borates, zirconates, chromates, titanates, and combinations thereof.

Embodiment 30: The aqueous composition of claim 29, wherein the aqueous composition has a pH of from 1 to 9, such as a pH of from 4 to 8.

Embodiment 31: The aqueous composition of any one of claims 1-30, wherein the gelling agent comprises a biopolymer, for example a polysaccharide such as guar, hydroxypropyl guar (HPG), carboxymethyl hydroxypropyl guar (CMHPG), xanthan, or a blend or copolymer thereof, and wherein the crosslinker is chosen from borates, zirconates, titanates, and combinations thereof.

Embodiment 32: The aqueous composition of claim 31, wherein the aqueous composition has a pH of greater than 9, such as a pH of from 9 to 12.

Embodiment 33: The aqueous composition of any one of claims 1-32, wherein the aqueous composition further comprises a proppant.

Embodiment 34: The aqueous composition of claim 33, wherein the proppant has a particle size of 140 mesh or less (e.g., 120 mesh or less, 100 mesh or less, 80 mesh or less, 60 mesh or less, 40 mesh or less, or 20 mesh or less).

Embodiment 35: The aqueous composition of claim 33 or claim 34, wherein the proppant is a micro-proppant.

Embodiment 36: The aqueous composition of any one of claims 33-35, wherein the proppant has a particle size of from 140 mesh to 625 mesh.

Embodiment 37: The aqueous composition of any one of claims 1-36, wherein the aqueous composition further comprises an acid, an alkali agent, a friction reducer, a polymer, a breaking agent, a biocide, a scale inhibitor, a pH adjusting agent, a non-emulsifier agent, an iron control agent, a chelating agent, a corrosion inhibitor, a clay stabilizing agent, a wettability alteration chemical, an anti-foam agent (e.g., chemical defoamer), a sulfide scavenger, a mobility control agent, a co-solvent, a surfactant, a surfactant package, or any combination thereof.

Embodiment 38: The aqueous composition of any one of claims 1-37, wherein the aqueous composition further comprises an encapsulated breaking agent.

Embodiment 39: The aqueous composition of claim 38, wherein the breaking agent is released from its encapsulant, thereby at least partially breaking the crosslinked gelling agent in the aqueous composition.

Embodiment 40: The aqueous composition of claim 39, wherein the breaking agent is released after crosslinking of the gelling agent.

Embodiment 41: The aqueous composition of any one of claims 38-40, wherein the breaking agent comprises an oxidant.

Embodiment 42: The aqueous composition of any one of claims 38-41, wherein the breaking agent comprises a peroxide, a persulfate, a perphosphate, a perborate, a percarbonate, a persilicate, an oxyacid of a halogen, an oxyanion of halogen, a peracid, a derivative thereof, or any combination thereof.

Embodiment 43: The aqueous composition of any one of claims 1-42, wherein the aqueous composition further comprises an encapsulated pH adjusting agent.

Embodiment 44: The aqueous composition of claim 43, wherein the pH adjusting agent is released from its encapsulant, thereby adjusting the pH of the aqueous composition.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. An aqueous composition comprising:
a gelling agent and an encapsulated crosslinker;
wherein crosslinking of the gelling agent within the aqueous composition occurs upon release of the crosslinker from the encapsulant.

2. The aqueous composition of claim 1, wherein upon crosslinking of the gelling agent, the aqueous composition increases in viscosity by at least one order of magnitude.

3. The aqueous composition of claim 1, wherein upon crosslinking of the gelling agent, the aqueous composition forms a gel.

4. The aqueous composition of claim 1, wherein prior to release of the crosslinker from its encapsulant, the aqueous composition has an apparent viscosity of 20 cP or less at 25° C. measured at a shear rate of 170 sec⁻¹.

5. The aqueous composition of claim 1, wherein upon crosslinking of the gelling agent, the aqueous composition has an apparent viscosity of at least 50 cP at 25° C. measured at a shear rate of 170 sec⁻¹.

6. The aqueous composition of claim 1, wherein the encapsulated crosslinker comprises a crosslinker at least partially encapsulated within a dissolvable coating, a frangible coating, a meltable coating, a soft-gel coating, or a degradable coating.

7. The aqueous composition of claim 6, wherein when the encapsulated crosslinker comprises a dissolvable coating, the dissolvable coating comprises a dissolvable salt, a soluble polymer, or any combination thereof.

8. The aqueous composition of claim 7, wherein when the encapsulated crosslinker comprises a frangible coating, the frangible coating comprises a polymeric coating.

9. The aqueous composition of claim 8, wherein the polymeric coating comprises polyvinylidene chloride (PVDC); a (meth)acrylate polymer, such as a crosslinked (meth)acrylate polymer; a resin, such as a phenolic resin or a urea formaldehyde resin; or a blend or copolymer thereof.

10. The aqueous composition of claim 6, wherein when the encapsulated crosslinker comprises a degradable coating, the degradable coating degrades in response to an external trigger.

11. The aqueous composition of claim 10, wherein the degradable coating is acid soluble, an ultrathin coating shattered by ultrasonic stimulus, or comprises swellable polymers that shrink in response to change in salinity.

12. The aqueous composition of claim 1, wherein the crosslinker comprises a solid crosslinker or a liquid crosslinker.

13. The aqueous composition of claim 12, wherein the liquid crosslinker is adsorbed to a solid carrier, an inert solid carrier, or any combination thereof.

14. The aqueous composition of claim 1, wherein the crosslinker is chosen from organic crosslinkers, aluminates, borates, zirconates, chromates, titanates, and combinations thereof.

15. The aqueous composition of claim 1, wherein the gelling agent comprises a polymer.

16. The aqueous composition of claim 15, wherein the polymer is chosen from partially hydrolyzed polyacrylamides (HPAMs or PHPAs), polyacrylamides, polyacrylic acid (PAA), polyvinyl alcohol (PVA), co-polymers of polyacrylamide (PAM), 2-acrylamido 2-methylpropane sulfonic acid (and/or sodium salt) commonly referred to as AMPS (e.i., acrylamido tertiobutyl sulfonic acid or ATBS), N-vinyl pyrrolidone (NVP), guar, hydroxypropyl guar (HPG), carboxymethyl hydroxypropyl guar (CMHPG), and xanthan, or any combination thereof.

17. The aqueous composition of claim 16, wherein the polymer is present in the aqueous composition at a concentration of at least 1 lbm/Mgal.

18. The aqueous composition of claim 16, wherein the polymer is present in the aqueous composition at a concentration of from 0.005% to 0.5% by weight of the aqueous composition.

19. The aqueous composition of claim 1, wherein the aqueous composition further comprises an acid, an alkali agent, a friction reducer, a polymer, a breaking agent, a biocide, a scale inhibitor, a pH adjusting agent, a non-emulsifier agent, an iron control agent, a chelating agent, a corrosion inhibitor, a clay stabilizing agent, a wettability alteration chemical, an anti-foam agent (e.g., chemical defoamer), a sulfide scavenger, a mobility control agent, a co-solvent, a surfactant, a surfactant package, or any combination thereof.

20. The aqueous composition of claim 1, wherein the aqueous composition further comprises an encapsulated breaking agent, an encapsulated pH adjusting agent, or any combination thereof.
